(19) United States
(12) Patent Application Publication
(10) Pub. No.: US 2026/0023607 A1
(43) Pub. Date: Jan. 22, 2026

(54) SECURE LCS PROVISIONING SYSTEM

(71) Applicant: Dell Products L.P., Round Rock, TX (US)

(72) Inventors: Douglas Lang Farley, Round Rock, TX (US); Srinivas Giri Raju Gowda, Fremont, CA (US); Ethan A. Kaley, North Kingstown, RI (US); Deepak Gaikwad, Natick, MA (US)

(21) Appl. No.: 18/774,335

(22) Filed: Jul. 16, 2024

(51) Int. Cl. G06F 9/50

(52) U.S. Cl. CPC G06F 9/5027

(57) ABSTRACT

A secure LCS provisioning system includes a resource system coupled to a resource management system and including a resource system operating system and an SCP device. The SCP device receives LCS initialization information for an LCS from the resource management system and provides it to the resource system operating system. The SCP device also receives vTPM information for the LCS from the resource management system and uses it to provide an LCS vTPM for the LCS in a secure SCP storage subsystem. The SCP device then provides a secure communication channel between the resource system operating system and the secure SCP storage subsystem, and identifies a location of the LCS vTPM in the secure SCP storage subsystem to the resource system operating system, allowing the resource system operating system to access the LCS vTPM and use it with the LCS initialization information to provide an LCS.

### BACKGROUND

The present disclosure relates generally to information handling systems, and more particularly to securely providing Logically Composed Systems (LCSs) using information handling systems.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as, for example, server devices (e.g., “Bare Metal Servers (BMSs)) and/or other computing devices known in the art, may be utilized to provide Logically Composed Systems (LCSs) that perform workloads. For example, a user or administrator may provide a request to perform a workload, a server device may be selected for providing the LCS that is configured to perform that workload, and the resources of that server device may then be subsequently used to provide the LCS that performs that workload. The provisioning of such an LCS includes the initialization the hardware used to provide the LCS and the subsequent provisioning of an LCS operating system for the LCS using that hardware, and conventional techniques for doing so can raise issues.

For example, conventional LCS provisioning systems initialize LCS operating systems using a physical Trusted Platform Module (TPM) device in the server device that is managed by a hypervisor or other operating system provided on the server device, but doing so requires that the hypervisor have full access to the contents of the physical TPM device, which increases the vulnerability of the physical TPM device as well as raises other security concerns, particularly when the resource system is used to provide multiple LCSs for different users. Furthermore, physical TPM devices are not sized to accommodate the provisioning of relatively large numbers of LCSs (e.g., conventional physical TPM devices are not sized for use in providing hundreds of LCSs), and do not have the durability and endurance to regularly swap out large numbers of LCSs, thus limiting the number and frequency of LCSs that may be provided on any server device, resulting in relatively inefficient use of server devices when providing LCSs.

Accordingly, it would be desirable to provide a secure LCS provisioning system that addresses the issues discussed above.

### SUMMARY

According to one embodiment, an Information Handling System (IHS) includes a resource system processing system; a resource system memory system that is coupled to the resource system processing system and that includes instructions that, when executed by the resource system processing system, cause the resource system processing system to provide a resource system operating system engine; a System Control Processor (SCP) processing system; and an SCP memory system that is coupled to the SCP processing system and that includes instructions that, when executed by the SCP processing system, cause the SCP processing system to provide an SCP engine that is configured to: receive, from a resource management system, Logically Composed System (LCS) initialization information for an LCS; provide the LCS initialization information to the resource system operating system engine; receive, from the resource management system, virtual Trusted Platform Module (vTPM) information for the LCS; provide, using the vTPM information, an LCS vTPM for the LCS in a secure SCP storage subsystem; provide a secure communication channel between the resource system processing system and the secure SCP storage subsystem; and identify, to the resource system operating system engine, a location of the LCS vTPM in the secure SCP storage subsystem, wherein the resource system operating system engine is configured to: access the LCS vTPM at the location in the secure SCP storage subsystem via the secure communication channel and use the LCS vTPM with the LCS initialization information to provide an LCS.

### BRIEF DESCRIPTION OF THE DRAWINGS

FIG. 1 is a schematic view illustrating an embodiment of an Information Handling System (IHS).

FIG. 2 is a schematic view illustrating an embodiment of an LCS provisioning system.

FIG. 3 is a schematic view illustrating an embodiment of an LCS provisioning subsystem that may be included in the LCS provisioning system of FIG. 2.

FIG. 4 is a schematic view illustrating an embodiment of a resource system that may be included in the LCS provisioning subsystem of FIG. 3.

FIG. 5 is a schematic view illustrating an embodiment of the provisioning of an LCS using the LCS provisioning system of FIG. 2.

FIG. 6 is a schematic view illustrating an embodiment of the provisioning of an LCS using the LCS provisioning system of FIG. 2.

FIG. 7 is a schematic view illustrating an embodiment of a secure LCS provisioning system that may be provided according to the teachings of the present disclosure.

FIG. 8 is a flow chart illustrating an embodiment of a method for securely providing an LCS.

FIG. 9A is a schematic view illustrating an embodiment of the secure LCS provisioning system of FIG. 7 operating during the method of FIG. 8.

FIG. 9B is a schematic view illustrating an embodiment of the secure LCS provisioning system of FIG. 7 operating during the method of FIG. 8.

FIG. 10 is a schematic view illustrating an embodiment of the secure LCS provisioning system of FIG. 7 operating during the method of FIG. 8.

FIG. 11 is a schematic view illustrating an embodiment of the secure LCS provisioning system of FIG. 7 operating during the method of FIG. 8.

FIG. 12 is a schematic view illustrating an embodiment of the secure LCS provisioning system of FIG. 7 operating during the method of FIG. 8.

FIG. 13 is a schematic view illustrating an embodiment of the secure LCS provisioning system of FIG. 7 operating during the method of FIG. 8.

FIG. 14 is a schematic view illustrating an embodiment of the secure LCS provisioning system of FIG. 7 operating during the method of FIG. 8.

FIG. 15 is a schematic view illustrating an embodiment of the secure LCS provisioning system of FIG. 7 operating during the method of FIG. 8.

FIG. 16A is a schematic view illustrating an embodiment of the secure LCS provisioning system of FIG. 7 operating during the method of FIG. 8.

FIG. 16B is a schematic view illustrating an embodiment of the secure LCS provisioning system of FIG. 7 operating during the method of FIG. 8.

FIG. 16C is a schematic view illustrating an embodiment of the secure LCS provisioning system of FIG. 7 operating during the method of FIG. 8.

FIG. 17 is a schematic view illustrating an embodiment of the secure LCS provisioning system of FIG. 7 operating during the method of FIG. 8.

FIG. 18A is a schematic view illustrating an embodiment of the secure LCS provisioning system of FIG. 7 operating during the method of FIG. 8.

FIG. 18B is a schematic view illustrating an embodiment of the secure LCS provisioning system of FIG. 7 operating during the method of FIG. 8.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

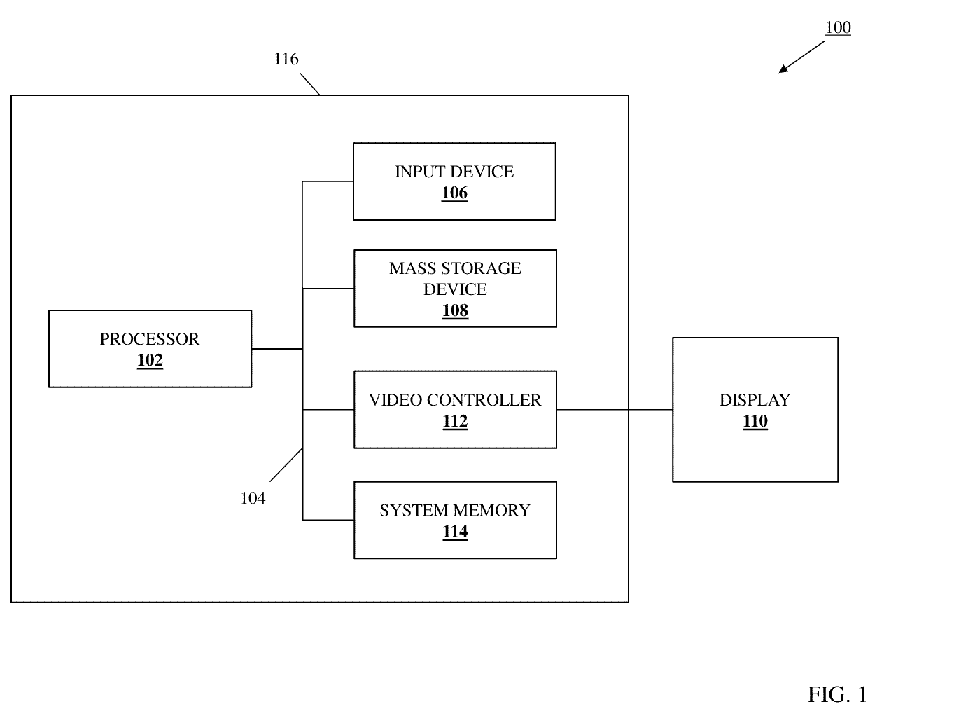

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

As discussed in further detail below, the secure Logically Composed System (LCS) provisioning systems and methods of the present disclosure may be utilized with LCSs, which one of skill in the art in possession of the present disclosure will recognize may be provided to users as part of an intent-based, as-a-Service delivery platform that enables multi-cloud computing while keeping the corresponding infrastructure that is utilized to do so “invisible” to the user in order to, for example, simplify the user/workload performance experience. As such, the LCSs discussed herein enable relatively rapid utilization of technology from a relatively broader resource pool, optimize the allocation of resources to workloads to provide improved scalability and efficiency, enable seamless introduction of new technologies and value-add services, and/or provide a variety of other benefits that would be apparent to one of skill in the art in possession of the present disclosure.

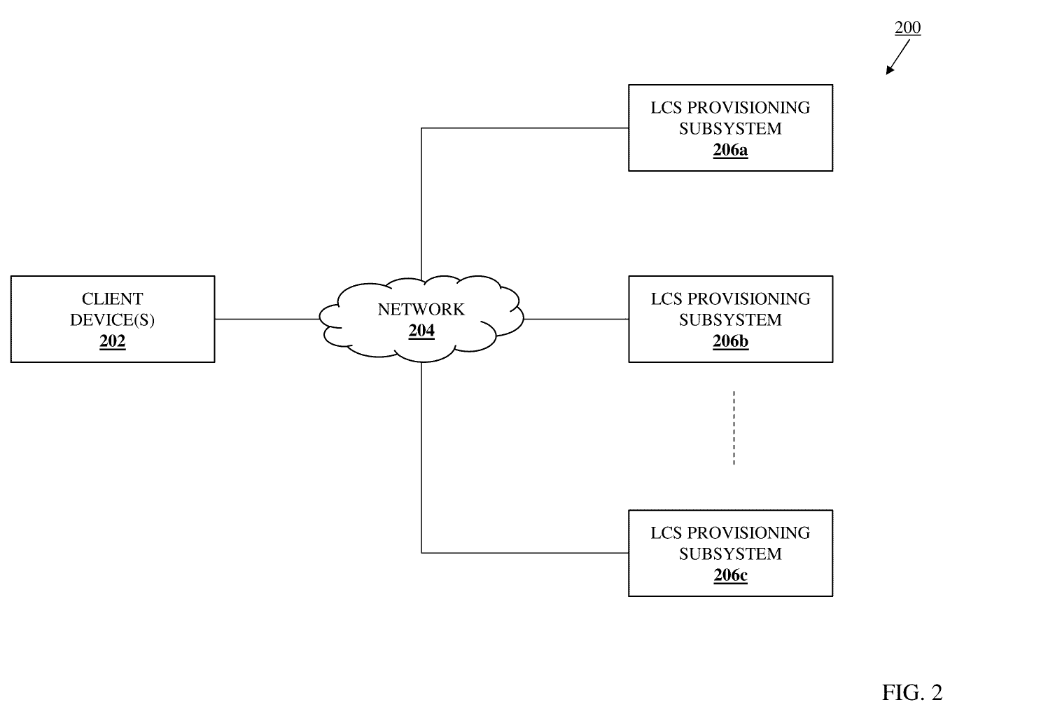

With reference to FIG. 2, an embodiment of a Logically Composed System (LCS) provisioning system 200 is illustrated that may be utilized to provide the secure LCS provisioning systems and methods of the present disclosure. In the illustrated embodiment, the LCS provisioning system 200 includes one or more client devices 202. In an embodiment, any or all of the client devices may be provided by the IHS 100 discussed above with reference to FIG. 1 and/or may include some or all of the components of the IHS 100, and in specific examples may be provided by desktop computing devices, laptop/notebook computing devices, tablet computing devices, mobile phones, and/or any other computing device known in the art. However, while illustrated and discussed as being provided by specific computing devices, one of skill in the art in possession of the present disclosure will recognize that the functionality of the client device(s) 202 discussed below may be provided by other computing devices that are configured to operate similarly as the client device(s) 202 discussed below, and that one of skill in the art in possession of the present disclosure would recognize as utilizing the LCSs described herein. As illustrated, the client device(s) 202 may be coupled to a network 204 that may be provided by a Local Area Network (LAN), the Internet, combinations thereof, and/or any of network that would be apparent to one of skill in the art in possession of the present disclosure.

As also illustrated in FIG. 2, a plurality of LCS provisioning subsystems 206a, 206b, and up to 206c are coupled to the network 204 such that any or all of those LCS provisioning subsystems 206a-206c may provide LCSs to the client device(s) 202 as discussed in further detail below. In an embodiment, any or all of the LCS provisioning subsystems 206a-206c may include one or more of the IHS 100 discussed above with reference to FIG. 1 and/or may include some or all of the components of the IHS 100. For example, in some of the specific examples provided below, each of the LCS provisioning subsystems 206a-206c may be provided by a respective datacenter or other computing device/computing component location (e.g., a respective one of the “clouds” that enables the “multi-cloud” computing discussed above) in which the components of that LCS provisioning subsystem are included. However, while a specific configuration of the LCS provisioning system 200 (e.g., including multiple LCS provisioning subsystems 206a-206c) is illustrated and described, one of skill in the art in possession of the present disclosure will recognize that other configurations of the LCS provisioning system 200 (e.g., a single LCS provisioning subsystem, LCS provisioning subsystems that span multiple datacenters/computing device/computing component locations, etc.) will fall within the scope of the present disclosure as well.

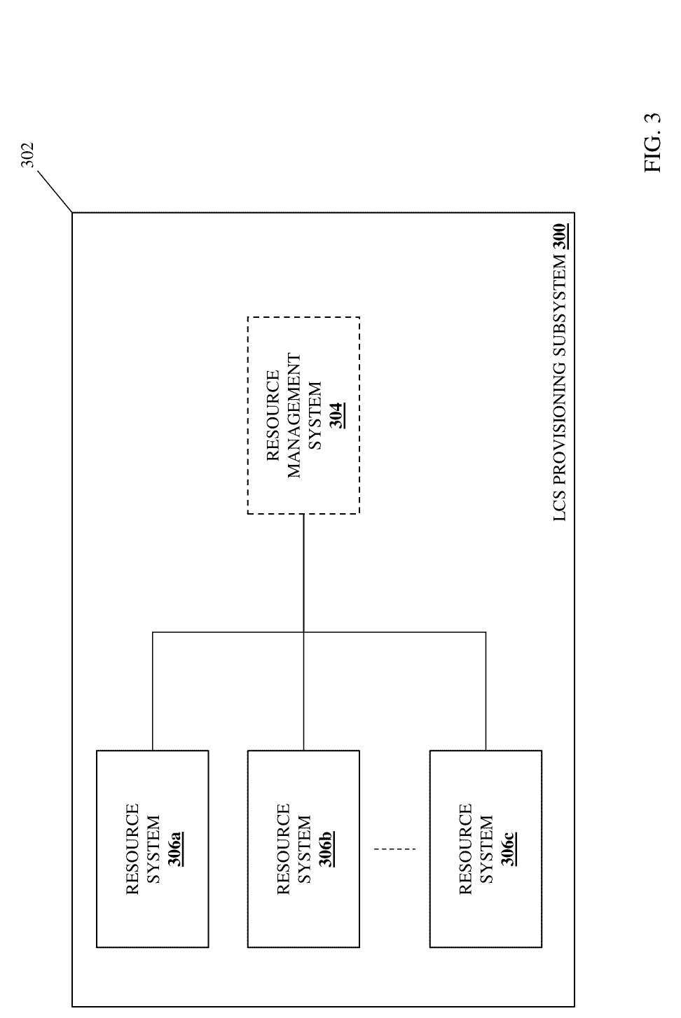

With reference to FIG. 3, an embodiment of an LCS provisioning subsystem 300 is illustrated that may provide any of the LCS provisioning subsystems 206a-206c discussed above with reference to FIG. 2. As such, the LCS provisioning subsystem 300 may include one or more of the IHS 100 discussed above with reference to FIG. 1 and/or may include some or all of the components of the IHS 100, and in the specific examples provided below may be provided by a datacenter or other computing device/computing component location in which the components of the LCS provisioning subsystem 300 are included. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

In the illustrated embodiment, the LCS provisioning subsystem 300 is provided in a datacenter 302, and includes a resource management system 304 coupled to a plurality of resource systems 306a, 306b, and up to 306c. In an embodiment, any of the resource management system 304 and the resource systems 306a-306c may be provided by the IHS 100 discussed above with reference to FIG. 1 and/or may include some or all of the components of the IHS 100. In the specific embodiments provided below, each of the resource management system 304 and the resource systems 306a-306c may include a System Control Processor (SCP) device that may be conceptualized as an “enhanced” SmartNIC device that may be configured to perform functionality that is not available in conventional SmartNIC devices such as, for example, the resource management functionality, LCS provisioning functionality, and/or other SCP functionality described herein.

In an embodiment, any of the resource systems 306a-306c may include any of the resources described below coupled to an SCP device that is configured to facilitate management of those resources by the resource management system 304. Furthermore, the SCP device included in the resource management system 304 may provide an SCP Manager (SCPM) subsystem that is configured to manage the SCP devices in the resource systems 306a-306c, and that performs the functionality of the resource management system 304 described below. In some examples, the resource management system 304 may be provided by a “stand-alone” system (e.g., that is provided in a separate chassis from each of the resource systems 306a-306c), and the SCPM subsystem discussed below may be provided by a dedicated SCP device, processing/memory resources, and/or other components in that resource management system 304. However, in other embodiments, the resource management system 304 may be provided by one of the resource systems 306a-306c (e.g., it may be provided in a chassis of one of the resource systems 306a-306c), and the SCPM subsystem may be provided by an SCP device, processing/memory resources, and/or any other any other components om that resource system.

As such, the resource management system 304 is illustrated with dashed lines in FIG. 3 to indicate that it may be a stand-alone system in some embodiments, or may be provided by one of the resource systems 306a-306c in other embodiments. Furthermore, one of skill in the art in possession of the present disclosure will appreciate how SCP devices in the resource systems 306a-306c may operate to “elect” or otherwise select one or more of those SCP devices to operate as the SCPM subsystem that provides the resource management system 304 described below. However, while a specific configuration of the LCS provisioning subsystem 300 is illustrated and described, one of skill in the art in possession of the present disclosure will recognize that other configurations of the LCS provisioning subsystem 300 will fall within the scope of the present disclosure as well.

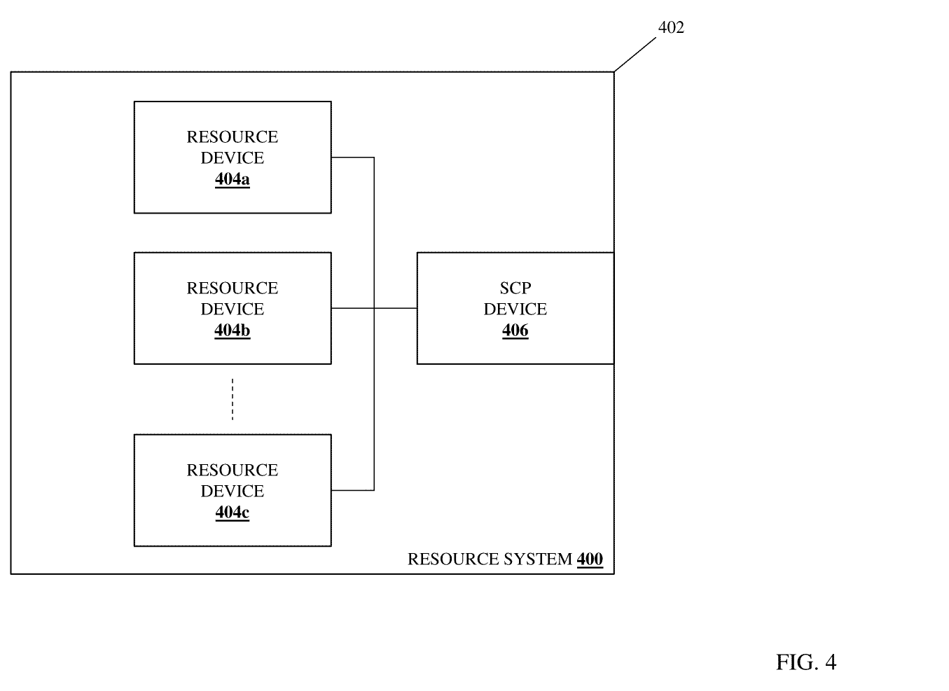

With reference to FIG. 4, an embodiment of a resource system 400 is illustrated that may provide any or all of the resource systems 306a-306c discussed above with reference to FIG. 3. In an embodiment, the resource system 400 may be provided by the IHS 100 discussed above with reference to FIG. 1 and/or may include some or all of the components of the IHS 100. In the illustrated embodiment, the resource system 400 includes a chassis 402 that houses the components of the resource system 400, only some of which are illustrated and discussed below. In the illustrated embodiment, the chassis 402 houses an SCP device 406. In an embodiment, the SCP device 406 may include a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide an SCP engine that is configured to perform the functionality of the SCP engines and/or SCP devices discussed below. Furthermore, the SCP device 406 may also include any of a variety of SCP components (e.g., hardware/software) that are configured to enable any of the SCP functionality described below.

In the illustrated embodiment, the chassis 402 also houses a plurality of resource devices 404a, 404b, and up to 404c, each of which is coupled to the SCP device 406. For example, the resource devices 404a-404c may include processing systems (e.g., first type processing systems such as those available from INTEL® Corporation of Santa Clara, California, United States, second type processing systems such as those available from ADVANCED MICRO DEVICES (AMD)® Inc. of Santa Clara, California, United States, Advanced Reduced Instruction Set Computer (RISC) Machine (ARM) devices, Graphics Processing Unit (GPU) devices, Tensor Processing Unit (TPU) devices, Field Programmable Gate Array (FPGA) devices, accelerator devices, etc.); memory systems (e.g., Persistence MEMory (PMEM) devices (e.g., solid state byte-addressable memory devices that reside on a memory bus), etc.); storage devices (e.g., Non-Volatile Memory express over Fabric (NVMe-oF) storage devices, Just a Bunch Of Flash (JBOF) devices, etc.); networking devices (e.g., Network Interface Controller (NIC) devices, etc.); and/or any other devices that one of skill in the art in possession of the present disclosure would recognize as enabling the functionality described as being enabled by the resource devices 404a-404c discussed below. As such, the resource devices 404a-404c in the resource systems 306a-306c/400 may be considered a “pool” of resources that are available to the resource management system 304 for use in composing LCSs.

To provide a specific example, the SCP devices described herein may operate to provide a Root-of-Trust (RoT) for their corresponding resource devices/systems, to provide an intent management engine for managing the workload intents discussed below, to perform telemetry generation and/or reporting operations for their corresponding resource devices/systems, to perform identity operations for their corresponding resource devices/systems, provide an image boot engine (e.g., an operating system image boot engine) for LCSs composed using a processing system/memory system controlled by that SCP device, and/or perform any other operations that one of skill in the art in possession of the present disclosure would recognize as providing the functionality described below. Further, as discussed below, the SCP devices describe herein may include Software-Defined Storage (SDS) subsystems, inference subsystems, data protection subsystems, Software-Defined Networking (SDN) subsystems, trust subsystems, data management subsystems, compression subsystems, encryption subsystems, and/or any other hardware/software described herein that may be allocated to an LCS that is composed using the resource devices/systems controlled by that SCP device. However, while an SCP device is illustrated and described as performing the functionality discussed below, one of skill in the art in possession of the present disclosure will appreciated that functionality described herein may be enabled on other devices while remaining within the scope of the present disclosure as well.

Thus, the resource system 400 may include the chassis 402 including the SCP device 406 connected to any combinations of resource devices. To provide a specific embodiment, the resource system 400 may provide a “Bare Metal Server” that one of skill in the art in possession of the present disclosure will recognize may be a physical server system that provides dedicated server hosting to a single tenant , and thus may include the chassis 402 housing a processing system and a memory system, the SCP device 406, as well as any other resource devices that would be apparent to one of skill in the art in possession of the present disclosure. However, in other specific embodiments, the resource system 400 may include the chassis 402 housing the SCP device 406 coupled to particular resource devices 404a-404c. For example, the chassis 402 of the resource system 400 may house a plurality of processing systems (i.e., the resource devices 404a-404c) coupled to the SCP device 406. In another example, the chassis 402 of the resource system 400 may house a plurality of memory systems (i.e., the resource devices 404a-404c) coupled to the SCP device 406. In another example, the chassis 402 of the resource system 400 may house a plurality of storage devices (i.e., the resource devices 404a-404c) coupled to the SCP device 406. In another example, the chassis 402 of the resource system 400 may house a plurality of networking devices (i.e., the resource devices 404a-404c) coupled to the SCP device 406. However, one of skill in the art in possession of the present disclosure will appreciate that the chassis 402 of the resource system 400 housing a combination of any of the resource devices discussed above will fall within the scope of the present disclosure as well.

As discussed in further detail below, the SCP device 406 in the resource system 400 will operate with the resource management system 304 (e.g., an SCPM subsystem) to allocate any of its resources devices 404a-404c for use in a providing an LCS. Furthermore, the SCP device 406 in the resource system 400 may also operate to allocate SCP hardware and/or perform functionality, which may not be available in a resource device that it has allocated for use in providing an LCS, in order to provide any of a variety of functionality for the LCS. For example, the SCP engine and/or other hardware/software in the SCP device 406 may be configured to perform encryption functionality, compression functionality, and/or other storage functionality known in the art, and thus if that SCP device 406 allocates storage device(s) (which may be included in the resource devices it controls) for use in a providing an LCS, that SCP device 406 may also utilize its own SCP hardware and/or software to perform that encryption functionality, compression functionality, and/or other storage functionality as needed for the LCS as well. However, while particular SCP-enabled storage functionality is described herein, one of skill in the art in possession of the present disclosure will appreciate how the SCP devices 406 described herein may allocate SCP hardware and/or perform other enhanced functionality for an LCS provided via allocation of its resource devices 404a-404c while remaining within the scope of the present disclosure as well.

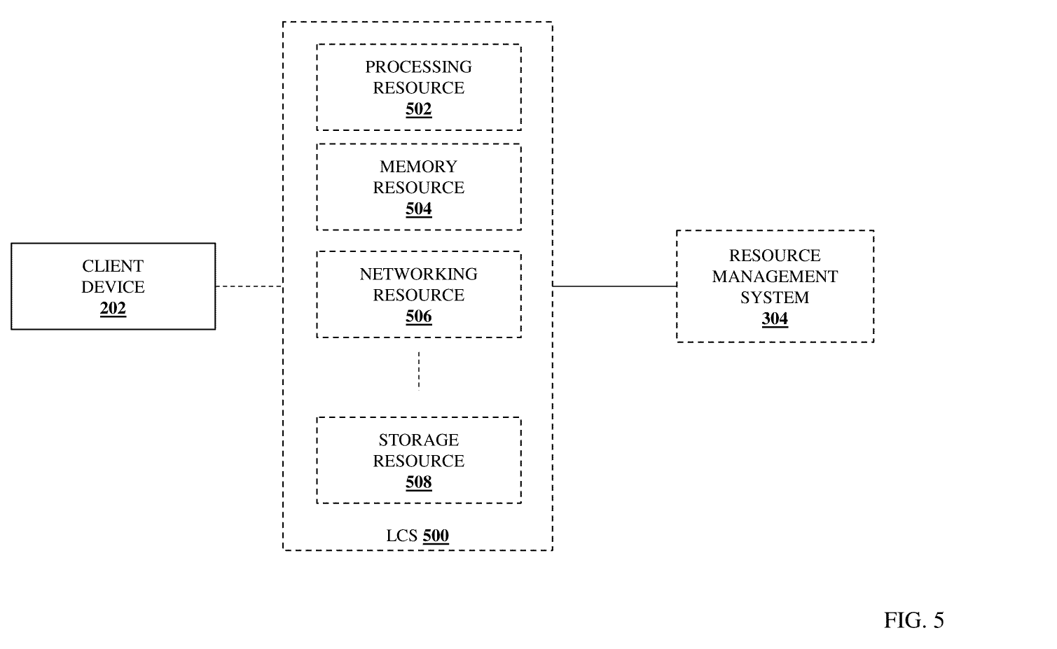

With reference to FIG. 5, an example of the provisioning of an LCS 500 to one of the client device(s) 202 is illustrated. For example, the LCS provisioning system 200 may allow a user of the client device 202 to express a “workload intent” that describes the general requirements of a workload that user would like to perform (e.g., “I need an LCS with 10 gigahertz (Ghz) of processing power and 8 gigabytes (GB) of memory capacity for an application requiring 20 terabytes (TB) of high-performance protected-object-storage for use with a hospital-compliant network”, or “I need an LCS for a machine-learning environment requiring Tensorflow processing with 3 TBs of Accelerator PMEM memory capacity”). As will be appreciated by one of skill in the art in possession of the present disclosure, the workload intent discussed above may be provided to one of the LCS provisioning subsystems 206a-206c, and may be satisfied using resource systems that are included within that LCS provisioning subsystem, or satisfied using resource systems that are included across the different LCS provisioning subsystems 206a-206c.

As such, the resource management system 304 in the LCS provisioning subsystem that received the workload intent may operate to compose the LCS 500 using resource devices 404a-404c in the resource systems 306a-306c/400 in that LCS provisioning subsystem, and/or resource devices 404a-404c in the resource systems 306a-306c/400 in any of the other LCS provisioning subsystems. FIG. 5 illustrates the LCS 500 including a processing resource 502 allocated from one or more processing systems provided by one or more of the resource devices 404a-404c in one or more of the resource systems 306a-306c/400 in one or more of the LCS provisioning subsystems 206a-206c, a memory resource 504 allocated from one or more memory systems provided by one or more of the resource devices 404a-404c in one or more of the resource systems 306a-306c/400 in one or more of the LCS provisioning subsystems 206a-206c, a networking resource 506 allocated from one or more networking devices provided by one or more of the resource devices 404a-404c in one or more of the resource systems 306a-306c/400 in one or more of the LCS provisioning subsystems 206a-206c, and/or a storage resource 508 allocated from one or more storage devices provided by one or more of the resource devices 404a-404c in one or more of the resource systems 306a-306c/400 in one or more of the LCS provisioning subsystems 206a-206c.

Furthermore, as will be appreciated by one of skill in the art in possession of the present disclosure, any of the processing resource 502, memory resource 504, networking resource 506, and the storage resource 508 may be provided from a portion of a processing system (e.g., a core in a processor, a time-slice of processing cycles of a processor, etc.), a portion of a memory system (e.g., a subset of memory capacity in a memory device), a portion of a storage device (e.g., a subset of storage capacity in a storage device), and/or a portion of a networking device (e.g., a portion of the bandwidth of a networking device). Further still, as discussed above, the SCP device(s) 406 in the resource systems 306a-306c/400 that allocate any of the resource devices 404a-404c that provide the processing resource 502, memory resource 504, networking resource 506, and the storage resource 508 in the LCS 500 may also allocate their SCP hardware and/or perform enhanced functionality (e.g., the enhanced storage functionality in the specific examples provided above) for any of those resources that may otherwise not be available in the processing system, memory system, storage device, or networking device allocated to provide those resources in the LCS 500.

With the LCS 500 composed using the processing resources 502, the memory resources 504, the networking resources 506, and the storage resources 508, the resource management system 304 may provide the client device 202 resource communication information such as, for example, Internet Protocol (IP) addresses of each of the systems/devices that provide the resources that make up the LCS 500, in order to allow the client device 202 to communicate with those systems/devices in order to utilize the resources that make up the LCS 500. As will be appreciated by one of skill in the art in possession of the present disclosure, the resource communication information may include any information that allows the client device 202 to present the LCS 500 to a user in a manner that makes the LCS 500 appear the same as an integrated physical system having the same resources as the LCS 500.

Thus, continuing with the specific example above in which the user provided the workload intent defining an LCS with a 10 Ghz of processing power and 8 GB of memory capacity for an application with 20 TB of high-performance protected object storage for use with a hospital-compliant network, the processing resources 502 in the LCS 500 may be configured to utilize 10 Ghz of processing power from processing systems provided by resource device(s) in the resource system(s), the memory resources 504 in the LCS 500 may be configured to utilize 8 GB of memory capacity from memory systems provided by resource device(s) in the resource system(s), the storage resources 508 in the LCS 500 may be configured to utilize 20 TB of storage capacity from high-performance protected-object-storage storage device(s) provided by resource device(s) in the resource system(s), and the networking resources 506 in the LCS 500 may be configured to utilize hospital-compliant networking device(s) provided by resource device(s) in the resource system(s).

Similarly, continuing with the specific example above in which the user provided the workload intent defining an LCS for a machine-learning environment for Tensorflow processing with 3 TBs of Accelerator PMEM memory capacity, the processing resources 502 in the LCS 500 may be configured to utilize TPU processing systems provided by resource device(s) in the resource system(s), and the memory resources 504 in the LCS 500 may be configured to utilize 3 TB of accelerator PMEM memory capacity from processing systems/memory systems provided by resource device(s) in the resource system(s), while any networking/storage functionality may be provided for the networking resources 506 and storage resources 508, if needed.

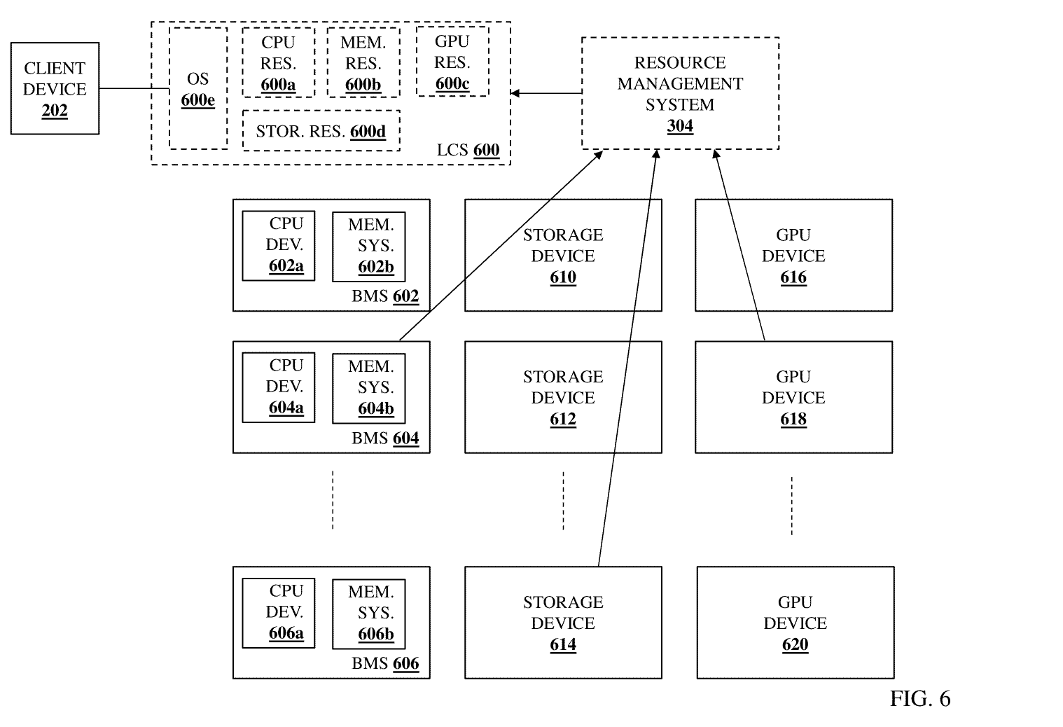

With reference to FIG. 6, another example of the provisioning of an LCS 600 to one of the client device(s) 202 is illustrated. As will be appreciated by one of skill in the art in possession of the present disclosure, many of the LCSs provided by the LCS provisioning system 200 will utilize a “compute” resource (e.g., provided by a processing resource such as an x86 processor, an AMD processor, an ARM processor, and/or other processing systems known in the art, along with a memory system that includes instructions that, when executed by the processing system, cause the processing system to perform any of a variety of compute operations known in the art), and in many situations those compute resources may be allocated from a Bare Metal Server (BMS) and presented to a client device 202 user along with storage resources, networking resources, other processing resources (e.g., GPU resources), and/or any other resources that would be apparent to one of skill in the art in possession of the present disclosure.

As such, in the illustrated embodiment, the resource systems 306a-306c available to the resource management system 304 include a Bare Metal Server (BMS) 602 having a Central Processing Unit (CPU) device 602a and a memory system 602b, a BMS 604 having a CPU device 604a and a memory system 604b, and up to a BMS 606 having a CPU device 606a and a memory system 606b. Furthermore, one or more of the resource systems 306a-306c includes resource devices 404a-404c provided by a storage device 610, a storage device 612, and up to a storage device 614. Further still, one or more of the resource systems 306a-306c includes resource devices 404a-404c provided by a Graphics Processing Unit (GPU) device 616, a GPU device 618, and up to a GPU device 620.

FIG. 6 illustrates how the resource management system 304 may compose the LCS 600 using the BMS 604 to provide the LCS 600 with CPU resources 600a that utilize the CPU device 604a in the BMS 604, and memory resources 600b that utilize the memory system 604b in the BMS 604. Furthermore, the resource management system 304 may compose the LCS 600 using the storage device 614 to provide the LCS 600 with storage resources 600d, and using the GPU device 318 to provide the LCS 600 with GPU resources 600c. As illustrated in the specific example in FIG. 6, the CPU device 604a and the memory system 604b in the BMS 604 may be configured to provide an operating system 600e that is presented to the client device 202 as being provided by the CPU resources 600a and the memory resources 600b in the LCS 600, with operating system 600e utilizing the GPU device 618 to provide the GPU resources 600c in the LCS 600, and utilizing the storage device 614 to provide the storage resources 600d in the LCS 600. The user of the client device 202 may then provide any application(s) on the operating system 600e provided by the CPU resources 600a/CPU device 604a and the memory resources 600b/memory system 604b in the LCS 600/BMS 604, with the application(s) operating using the CPU resources 600a/CPU device 604a, the memory resources 600b/memory system 604b, the GPU resources 600c/GPU device 618, and the storage resources 600d/storage device 614.

Furthermore, as discussed above, the SCP device(s) 406 in the resource systems 306a-306c/400 that allocates any of the CPU device 604a and memory system 604b in the BMS 604 that provide the CPU resource 600a and memory resource 600b, the GPU device 618 that provides the GPU resource 600c, and the storage device 614 that provides storage resource 600d, may also allocate SCP hardware and/or perform enhanced functionality (e.g., the enhanced storage functionality in the specific examples provided above) for any of those resources that may otherwise not be available in the CPU device 604a, memory system 604b, storage device 614, or GPU device 618 allocated to provide those resources in the LCS 500.

However, while simplified examples are described above, one of skill in the art in possession of the present disclosure will appreciate how multiple devices/systems (e.g., multiple CPUs, memory systems, storage devices, and/or GPU devices) may be utilized to provide an LCS. Furthermore, any of the resources utilized to provide an LCS (e.g., the CPU resources, memory resources, storage resources, and/or GPU resources discussed above) need not be restricted to the same device/system, and instead may be provided by different devices/systems over time (e.g., the GPU resources 600c may be provided by the GPU device 618 during a first time period, by the GPU device 616 during a second time period, and so on) while remaining within the scope of the present disclosure as well. Further still, while the discussions above imply the allocation of physical hardware to provide LCSs, one of skill in the art in possession of the present disclosure will recognize that the LCSs described herein may be composed similarly as discussed herein from virtual resources. For example, the resource management system 304 may be configured to allocate a portion of a logical volume provided in a Redundant Array of Independent Disk (RAID) system to an LCS, allocate a portion/time-slice of GPU processing performed by a GPU device to an LCS, and/or perform any other virtual resource allocation that would be apparent to one of skill in the art in possession of the present disclosure in order to compose an LCS.

Similarly as discussed above, with the LCS 600 composed using the CPU resources 600a, the memory resources 600b, the GPU resources 600c, and the storage resources 600d, the resource management system 304 may provide the client device 202 resource communication information such as, for example, Internet Protocol (IP) addresses of each of the systems/devices that provide the resources that make up the LCS 600, in order to allow the client device 202 to communicate with those systems/devices in order to utilize the resources that make up the LCS 600. As will be appreciated by one of skill in the art in possession of the present disclosure, the resource communication information allows the client device 202 to present the LCS 600 to a user in a manner that makes the LCS 600 appear the same as an integrated physical system having the same resources as the LCS 600.

As will be appreciated by one of skill in the art in possession of the present disclosure, the LCS provisioning system 200 discussed above solves issues present in conventional Information Technology (IT) infrastructure systems that utilize “purpose-built” devices (server devices, storage devices, etc.) in the performance of workloads and that often result in resources in those devices being underutilized. This is accomplished, at least in part, by having the resource management system(s) 304 “build” LCSs that satisfy the needs of workloads when they are deployed. As such, a user of a workload need simply define the needs of that workload via a “manifest” expressing the workload intent of the workload, and resource management system 304 may then compose an LCS by allocating resources that define that LCS and that satisfy the requirements expressed in its workload intent, and present that LCS to the user such that the user interacts with those resources in same manner as they would physical system at their location having those same resources.

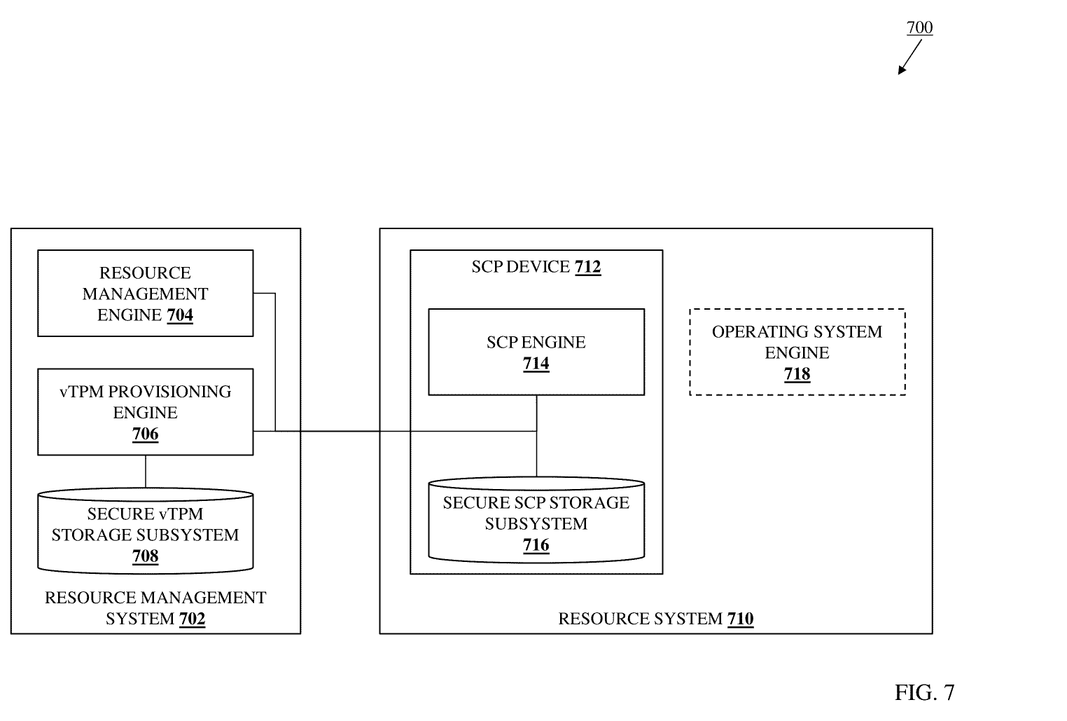

Referring now to FIG. 7, an embodiment of a secure LCS provisioning system 700 is illustrated that may be provided according to the teachings of the present disclosure. In the illustrated embodiment, the secure LCS provisioning system 700 may be provided using the LCS provisioning system 200 described above with reference to FIG. 2 and the LCS provisioning subsystem 300 described above with reference to FIG. 3, and may operate similarly as described with reference to FIGS. 5 and 6. The LCS provisioning system 700 includes a resource management system 702 that may be provided by the resource management system 304 of FIGS. 3, 5, and/or 6.

In an embodiment, the resource management system 702 may be provided by the IHS 100 discussed above with reference to FIG. 1, and/or may include some or all of the components of the IHS 100. In the illustrated embodiment, the resource management system 702 include a resource management processing system (not illustrated, but which may include the processor 102 discussed above with reference to FIG. 1 such as a Central Processing Unit (CPU)) that is coupled to a resource management memory system (not illustrated, but which may include the memory 114 discussed above with reference to FIG. 1 such as Dynamic Random Access Memory (DRAM)) that include instructions that, when executed by the resource management processing system, cause the resource management processing system to provide a resource management engine 704 that is configured to perform the functionality of the resource management engines and/or resource management systems described below. For example, the resource management engine 704 may be configured to perform any of the LCS composing operations described above to compose LCSs using resource systems, as well as any other resource management functionality that would be apparent to one of skill in the art in possession of the present disclosure.

Furthermore, the resource management memory system may also include instructions that, when executed by the resource management processing system, cause the resource management processing system to provide a virtual Trusted Platform Module (vTPM) provisioning engine 706 that is configured to perform the functionality of the vTPM provisioning engines and/or resource management systems described below. For example, the vTPM provisioning engine 706 may be configured to perform any of the vTPM composition operations and/or vTPM retrieval and provisioning operations described below to provide LCS vTPMs for LCSs that will be provided using resource systems, as well as any other vTPM provisioning functionality that would be apparent to one of skill in the art in possession of the present disclosure. To provide a specific example, the vTPM provisioning engine 706 may be provided by a Hardware Security Module (HSM) that is provided by the resource management processing system/resource management memory system described above, although other vTPM provisioning engines will fall within the scope of the present disclosure as well. As can be seen in FIG. 7, the vTPM provisioning engine 706 is coupled to the resource management engine 704, and that coupling may be provided as a connection between respective processors, a software/engine “coupling” provided between the engines provided by the same processor, and/or any other coupling that would be apparent to one of skill in the art in possession of the present disclosure.

Further still, the resource management system 702 may include a resource management storage device that is coupled to the vTPM provisioning engine 706 (e.g., via a coupling between the resource management storage device and the resource management processing system) and that provides a secure vTPM storage subsystem 708 that is configured to store the LCS vTPMs for any LCSs composed or otherwise provided by the resource management system 702 as described herein, while also including a vTPM/LCS mapping that maps any LCS vTPM stored in the secure vTPM storage subsystem 708 to its corresponding LCS. In a specific example, the HSM that provides vTPM provisioning engine 706 as described above may utilize HSM key management techniques to secure the secure vTPM storage subsystem 708, although other techniques for securing the vTPM storage subsystem in the resource management system 702 will fall within the scope of the present disclosure as well. However, while a specific resource management system 702 has been illustrated and described, one of skill in the art in possession of the present disclosure will recognize how resource management systems provided according to the teachings of the present disclosure may include a variety of components and/or component configurations for providing the secure LCS provisioning functionality described below while remaining within the scope of the present disclosure.

The LCS provisioning system 700 also includes a resource system 710 that one of skill in the art in possession of the present disclosure will appreciate may be used to securely provide the LCS as described below. As will be appreciated by one of skill in the art in possession of the present disclosure, the resource system 710 may be provided by any of the resource systems 306a, 306b, and 306c of FIG. 3; the resource system 400 of FIG. 4; the BMSs 602, 604, and 606 of FIG. 6; and/or any other resource systems described above. In the illustrated embodiment, the resource system 704 includes an SCP device 712 that may be provided by the SCP device 406 discussed above with reference to FIG. 4, and/or any other SCP device described herein.

Similarly as described above, the SCP device 712 may include an SCP processing system (not illustrated, but which may include the processor 102 discussed above with reference to FIG. 1) and an SCP memory system (not illustrated, but which may include the memory 114 discussed above with reference to FIG. 1) that is coupled to the SCP processing system and that includes instructions that, when executed by the SCP processing system, cause the SCP processing system to provide an SCP engine 714 that is configured to perform the functionality of the SCP engines and/or SCP devices discussed below.

Furthermore, the SCP device 714 also includes a secure SCP storage subsystem 716 that is coupled to the SCP engine 714 (e.g., via a coupling between the SCP processing system and the secure memory subsystem 710), and may be provided by the SCP memory system that provides the SCP engine 714, as well as any other memory/storage subsystems that are included in or otherwise accessible to the SCP engine 708. As such, while illustrated as being included in the SCP device 712, one of skill in the art in possession of the present disclosure will appreciate how the secure SCP storage subsystem 716 may be provided outside the SCP device 712 while being accessible to the SCP engine 714 while remaining within the scope of the present disclosure as well. As will be appreciated by one of skill in the art in possession of the present disclosure, the secure SCP storage subsystem 716 may be “secured” y using Software Guard eXtensions (SGX) or Total Memory Encryption (TME) available from INTEL® Corporation of Santa Clara, California, United States; ARM® Security Extensions available from ARM® of Santa Clara, California, United States; as well as using other memory securing techniques that would be apparent to one of skill in the art in possession of the present disclosure. As will be appreciated by one of skill in the art in possession of the present disclosure, the secure SCP storage subsystem 716 may be sized based on a number of LCSs that are expected to be provided by the resource system 710/SCP device 712 (which can include hundreds of LCSs as described above), the migration frequency of LCS with respect to the resource system 710/SCP device 712, and/or other factors that address the issues with the use of physical TPM devices in conventional resource systems discussed above.

As discussed above, the resource system 710 also includes a host processing system (not illustrated, but which may include the processor 102 discussed above with reference to FIG. 1 such as a Central Processing Unit (CPU) or other host processing system known in the art, the CPU devices 602a-606a in the BMSs 602-606, respectively, and/or other “host” processing systems that would be apparent to one of skill in the art in possession of the present disclosure) and a host memory system (not illustrated, but which may include the memory 114 discussed above with reference to FIG. 1 such as a DRAM or other host memory system known in the art, the memory systems 602b-606b in the BMSs 602-606, respectively, and/or other “host” memory systems that would be apparent to one of skill in the art in possession of the present disclosure) that may be configured by the SCP engine 714 in the SCP device 712 to provide an operating system engine 718 (e.g., a microvisor engine in some of the examples provided below) that is configured to provide an operating system (e.g., a microvisor in some of the examples provided below) for the resource system 710 that may be used to provide the LCS as described in further detail below.

However, while a specific secure LCS provisioning system 700 that may be provided according to teachings of the present disclosure has been illustrated and described, one of skill in the art in possession of the present disclosure will appreciate how the secure LCS provisioning system of the present disclosure may be provided using a variety of components and/or component configurations while remaining within the scope of the present disclosure as well.

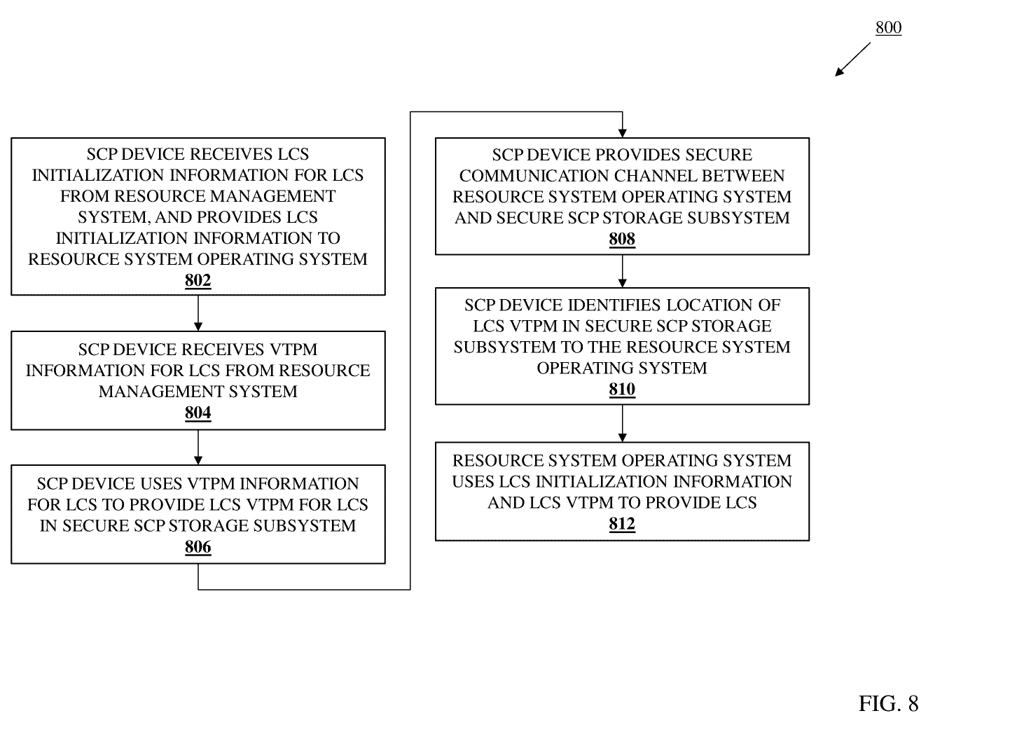

Referring now to FIG. 8, an embodiment of a method 800 for securely providing a Logically Composed System (LCS) is illustrated. As discussed below, the systems and methods of the present disclosure use an SCP device to provide the LCS initialization information and provide access to the vTPM needed by a resource system operating system to provide an LCS. For example, the secure LCS provisioning system of the present disclosure may include a resource system coupled to a resource management system and including a resource system operating system and an SCP device. The SCP device receives LCS initialization information for an LCS from the resource management system and provides it to the resource system operating system. The SCP device also receives vTPM information for the LCS from the resource management system and uses it to provide an LCS vTPM for the LCS in a secure SCP storage subsystem. The SCP device then provides a secure communication channel between the resource system operating system and the secure SCP storage subsystem, and identifies a location of the LCS vTPM in the secure SCP storage subsystem to the resource system operating system, allowing the resource system operating system to access the LCS vTPM and use it with the LCS initialization information to provide an LCS. As such, the provisioning of LCSs is secured by the SCP device and, as described below, the migration of such LCSs is simplified as well.

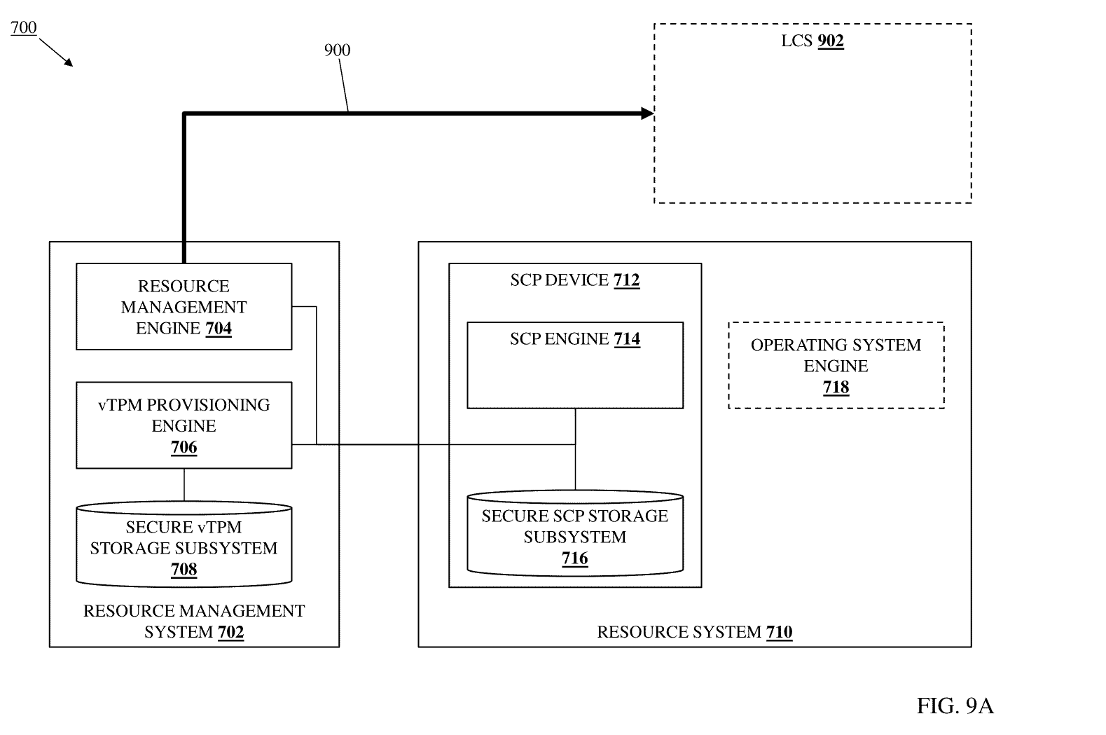

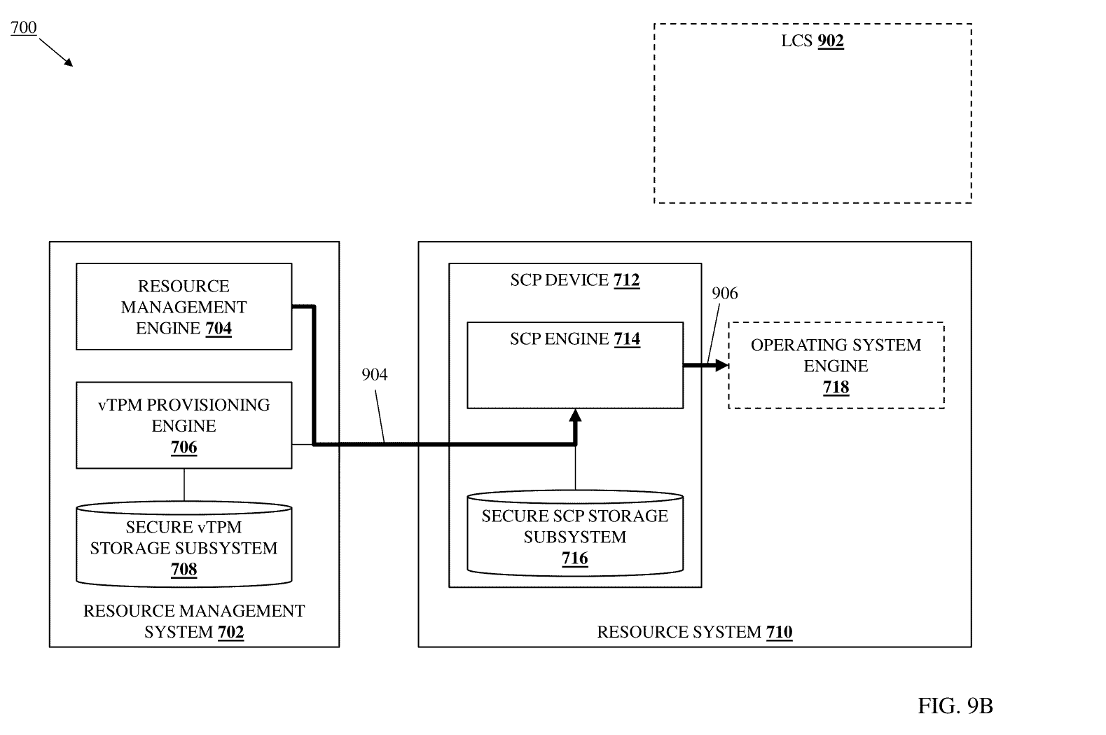

The method 800 begins at block 802 where an SCP device receives LCS initialization information for an LCS from a resource management system, and provides the LCS initialization information to a resource system operating system. With reference to FIG. 9A, during or prior to the method 800, the resource management engine 704 in the resource management system 702 may perform LCS composition operations 900 to compose an LCS 902 in response a workload intent provided by a user substantially as described in detail above. With reference to FIG. 9B, in an embodiment of block 802 and following the composing of the LCS 902, the resource management engine 704 may perform LCS initialization information transmission operations 904 that include transmitting LCS initialization information to the SCP engine 714 in the SCP device 712 of the resource system 710.

For example, at block 802 the resource management engine 704 may use a Basic Input/Output System (BIOS)/Unified Extensible Firmware Interface (UEFI) template to generate a BIOS/UEFI block that provides the LCS initialization information and that may define the hardware topology that will be used to provide the LCS 902, the configuration parameters for an LCS BIOS that will provide an LCS operating system for the LCS 902 (e.g., Advanced Configuration and Power Interface (ACPI) and System Management BIOS (SMBIOS) constructs used by that LCS BIOS to initialize the LCS operating system for the LCS 902), virtual hardware descriptors for the LCS 902, and/or any other information that one of skill in the art in possession of the present disclosure would recognize as being required to initialize the LCS 902 as described in further detail below.

In response to receiving the LCS initialization information, the SCP engine 714 in the SCP device 712 of the resource system 710 may perform LCS initialization information provision operations 906 that include transmitting the LCS initialization information to the operating system engine 718 (e.g., by transmitting the LCS initialization information to the host processing system that provides the operating system engine 718, with the host processing system storing that LCS initialization information in the host memory system that is used to provide the operating system engine 718). As such, following block 802, the operating system engine 718 may store the BIOS/UEFI block that is configured to initialize the LCS 902 that was composed by resource management engine 704 in the resource management system 702.

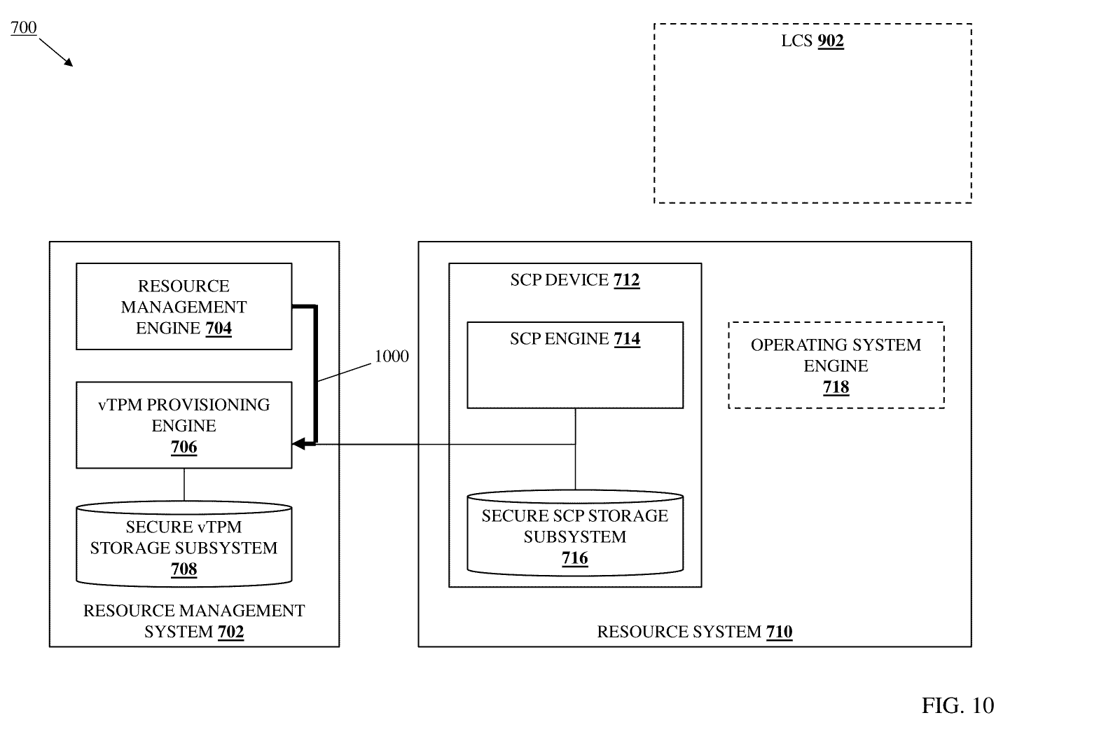

The method 800 then proceeds to block 804 where the SCP device receives vTPM information for the LCS from the resource management system. With reference to FIG. 10, in an embodiment of block 804 and subsequent to providing the LCS initialization information to the SCP device 712/operating system engine 718, the resource management engine 704 in the resource management system 702 may perform vTPM information provisioning instruction operations 1000 that include generating a vTPM information provisioning instruction and transmitting that vTPM information provisioning instruction to the vTPM provisioning engine 706. As discussed in further detail below, the vTPM information provisioning instruction may include LCS attributes of the LCS 902 (i.e., the hardware and software composition of the LCS 902 that was composed based on the workload intent as described above), along with an instruction to the vTPM provisioning engine 706 to either retrieve vTPM information for an LCS with identical attributes that was previously generated and stored in the secure vTPM storage subsystem 708, or generate vTPM information for the LCS 902 based on the LCS attributes, and provide that vTPM information to the SCP device 712 in the resource system 712.

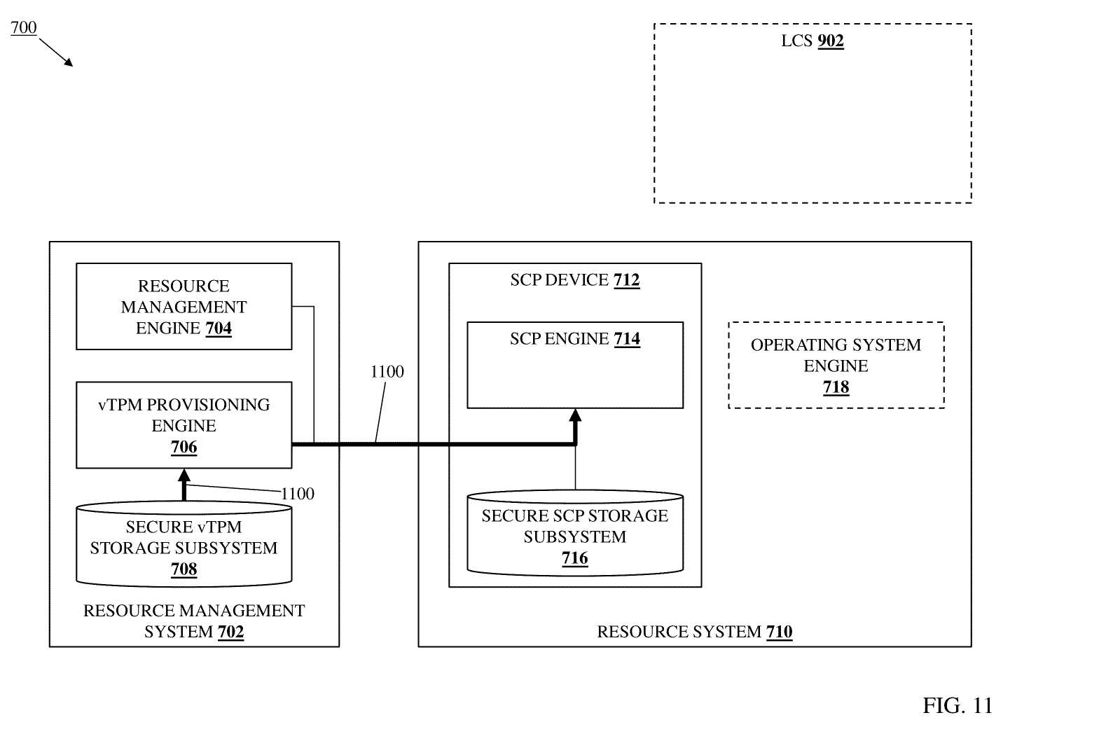

With reference to FIG. 11, at block 804 and in response to receiving the vTPM information provisioning instruction, the vTPM provisioning engine 706 may perform vTPM information provisioning operations 1100 that, in the illustrated example, include retrieving vTPM information for the LCS 902 from the secure vTPM storage subsystem 708 (i.e., vTPM information that was previously generated for another LCS with attributes identical to the attributes of the LCS 902 that was composed at block 802), encrypting and signing the vTPM information for the LCS 902 to provide encrypted vTPM information for the LCS 902 (e.g., using HSM keys as described in the specific examples provided above), and transmitting the encrypted/signed vTPM information for the LCS 902 to the SCP engine 714 in the SCP device 712 of the resource system 710. However, as described above, in some embodiments the vTPM information provisioning operations 1100 may include generating vTPM information for the LCS 902 based on the attributes of the LCS 902 included in the vTPM information provisioning instruction, encrypting and signing that vTPM information for the LCS 902 to provide encrypted vTPM information for the LCS 902 (e.g., using HSM keys as described in the specific examples provided above), and transmitting the encrypted/signed vTPM information for the LCS 902 to the SCP engine 714 in the SCP device 712 of the resource system 710.

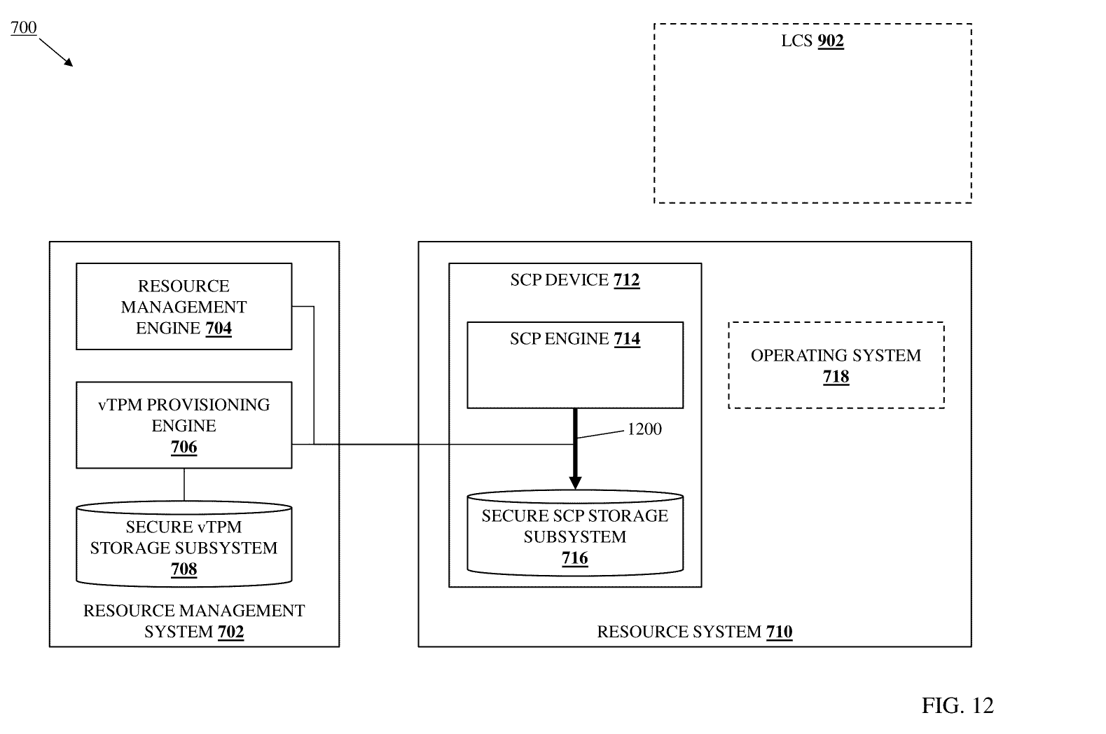

As discussed in further detail below, the vTPM information is configured for use in providing an LCS vTPM for the LCS 902, and may provide cryptographic functions, key storage, a Non-Volatile Random Access Memory (NVRAM) for the storage of counters and other data, , and/or other vTPM information that one of skill in the art in possession of the present disclosure would recognize as allowing an LCS vTPM for an LCS to be provided. With reference to FIG. 12, in an embodiment of block 804 and in response to receiving the vTPM information, the SCP engine 714 in the SCP device 712 of the resource system 710 may perform vTPM information storage operations 1200 that include storing the encrypted/signed vTPM information for the LCS 902 in the secure SCP storage subsystem 716.

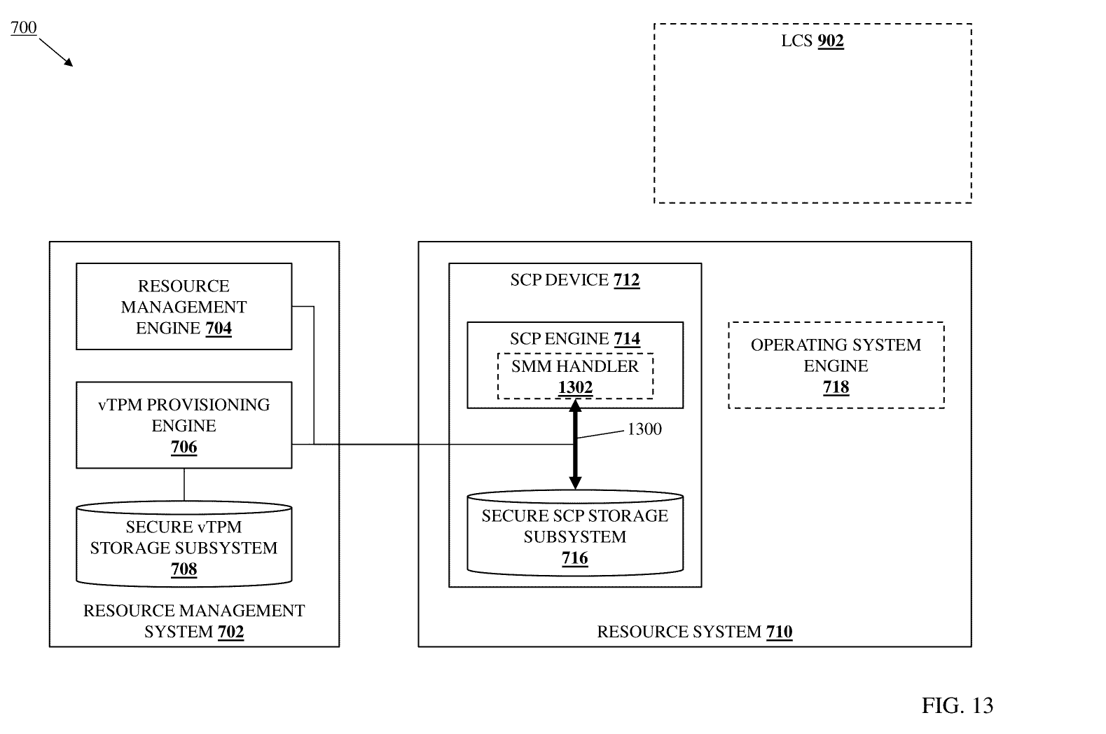

The method 800 then proceeds to block 806 where the SCP device uses the vTPM information for the LCS to provide an LCS vTPM for the LCS in a secure SCP storage subsystem. With reference to FIG. 13, in an embodiment of block 806 and subsequent to storing the vTPM information for the LCS 902 in the secure SCP storage subsystem 716, the SCP engine 714 in the SCP device 712 of the resource system 710 may perform vTPM provisioning operations 1300 that include entering an System Management Mode (SMM) in which an SMM handler 1302 is provided by the SCP engine 714, using the SMM handler 1302 to retrieve the encrypted/signed vTPM information for the LCS 902 from the secure SCP storage subsystem 716, decrypting the encrypted/signed vTPM information for the LCS 902 to provide signed vTPM information for the LCS 902, and authenticating the signed vTPM information for the LCS 902 (e.g., using a public key associated with the private key that was used to sign the signed vTPM information for the LCS 902).

In response to authenticating the vTPM information for the LCS 902, the SCP engine 714 in the SCP device 712 of the resource system 710 may then use the vTPM information to provide an LCS vTPM for the LCS 902 in the secure SCP storage subsystem 716. For example, the use of the vTPM information for the LCS 902 to provide the LCS vTPM for the LCS 902 may include providing a protocol interface for vTPM communications, populating configuration registers, and/or performing other vTPM provisioning operations that would be apparent to one of skill in the art in possession of the present disclosure. In some embodiments, the vTPM provisioning operations 1302 may also include mapping the LCS vTPM to the LCS 902 in a per-LCS/vTPM mapping that is stored in the secure SCP storage subsystem 716. Following the provision of the LCS vTPM for the LCS 902 in the secure SCP storage subsystem 716, the SCP engine 714 may exit the SMM.

As such, one of skill in the art in possession of the present disclosure will appreciate how the SCP device 712 may operate as a secure context for the resource system 710 that decrypts encrypted vTPM information for LCSs and uses it to provide vTPMs for those LCSs while in a SMM, which one of skill in the art in possession of the present disclosure will recognize enhances the security of the secure SCP storage subsystem 716, as the SMM provides an operating mode for the SCP device 712/SCP engine 714 during which all other engine executions are suspended and the SMM handler 1302 operates with relatively high privileges in order to access information stored in the secure SCP storage subsystem 716.

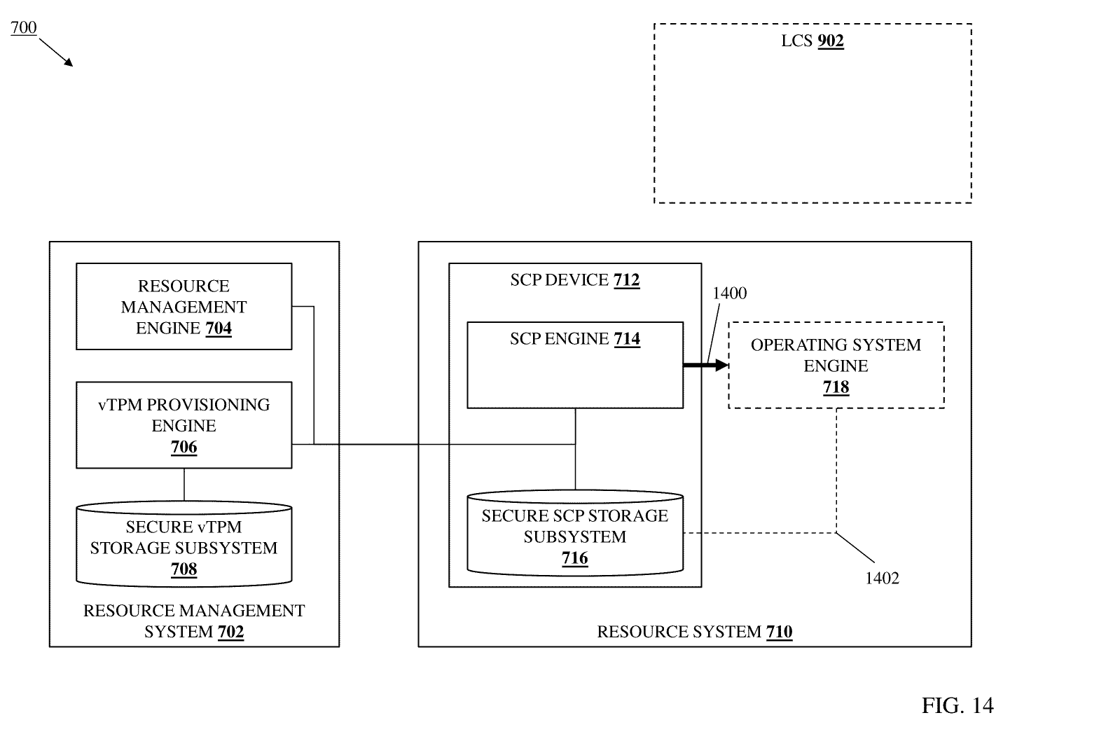

The method 800 then proceeds to block 808 where the SCP device provides a secure communication channel between the resource system operating system and the secure SCP storage subsystem. With reference to FIG. 14, in an embodiment of block 808, the SCP engine 714 in the SCP device 712 of the resource system 710 may perform secure communication channel provisioning operations 1400 that include providing a secure communication channel 1402 between the operating system engine 718 and the secure SCP storage subsystem 716. For example, the secure communication channel provisioning operations 1400 may include providing an Application Programming Interface (API) for the operating system engine 718 that is configured for use by the operating system engine 718 in accessing the secure SCP storage subsystem 716 (e.g., in-band or out-of-band), and/or performing other operations that one of skill in the art in possession of the present disclosure would recognize as creating a secure communication channel that allows the operating system engine 718 to securely access the data stored in the secure SCP storage subsystem 716.

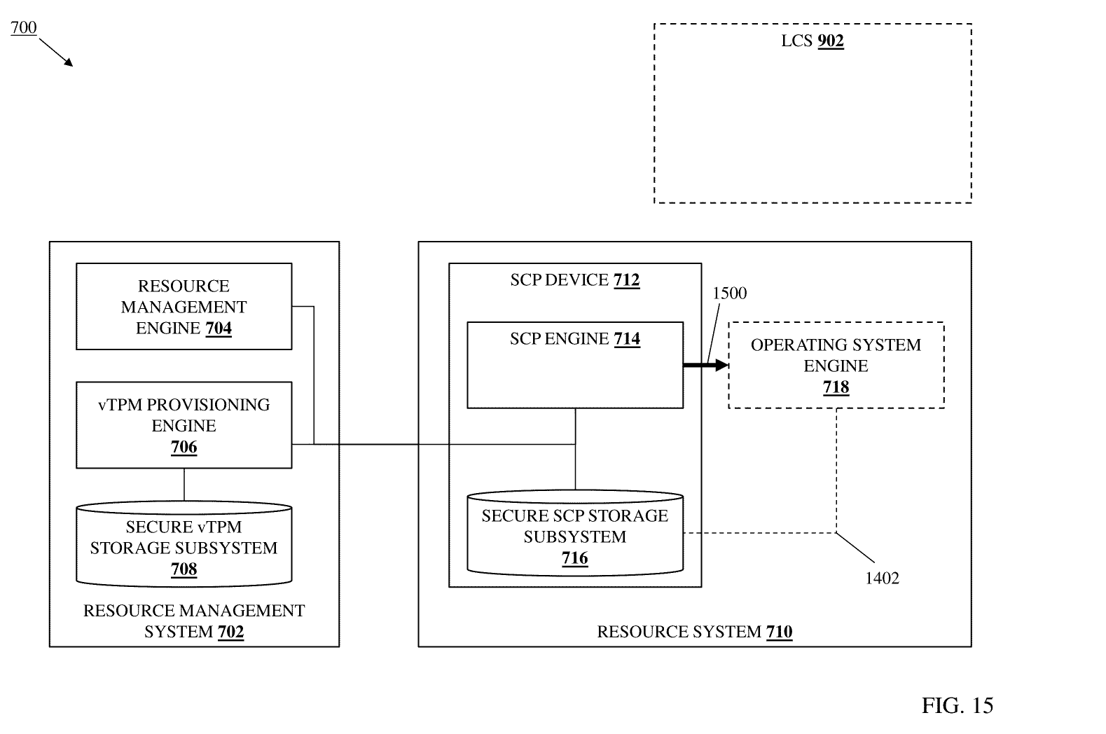

The method 800 then proceeds to block 810 where the SCP device identifies a location of the LCS vTPM in the secure SCP storage subsystem to the resource system operating system. With reference to FIG. 15, in an embodiment of block 810, the SCP engine 714 in the SCP device 712 of the resource system 710 may perform LCS vTPM location identification operations 1500 that include identifying a location of the LCS vTPM for the LCS 902 in the secure SCP storage subsystem 716 to the operating system engine 718. For example, the LCS vTPM location identification operations 1500 may include determining the memory offsets in the secure SCP storage subsystem 716 at which the LCS vTPM for the LCS 902 is stored, and providing those memory offsets to the operating system engine 718, as well as performing any other vTPM location identification operations that one of skill in the art in possession of the present disclosure would recognize as allowing the operating system engine 718 to access the LCS vTPM for the LCS 902 in the secure SCP storage subsystem 716 as described in further detail below.

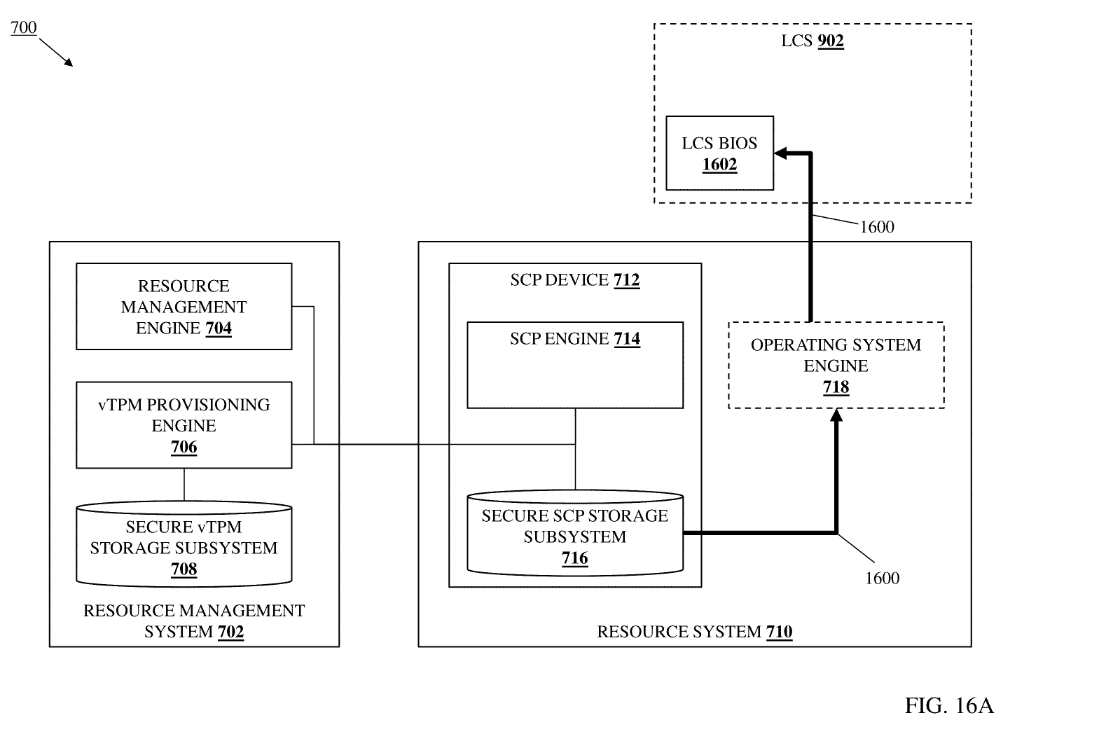

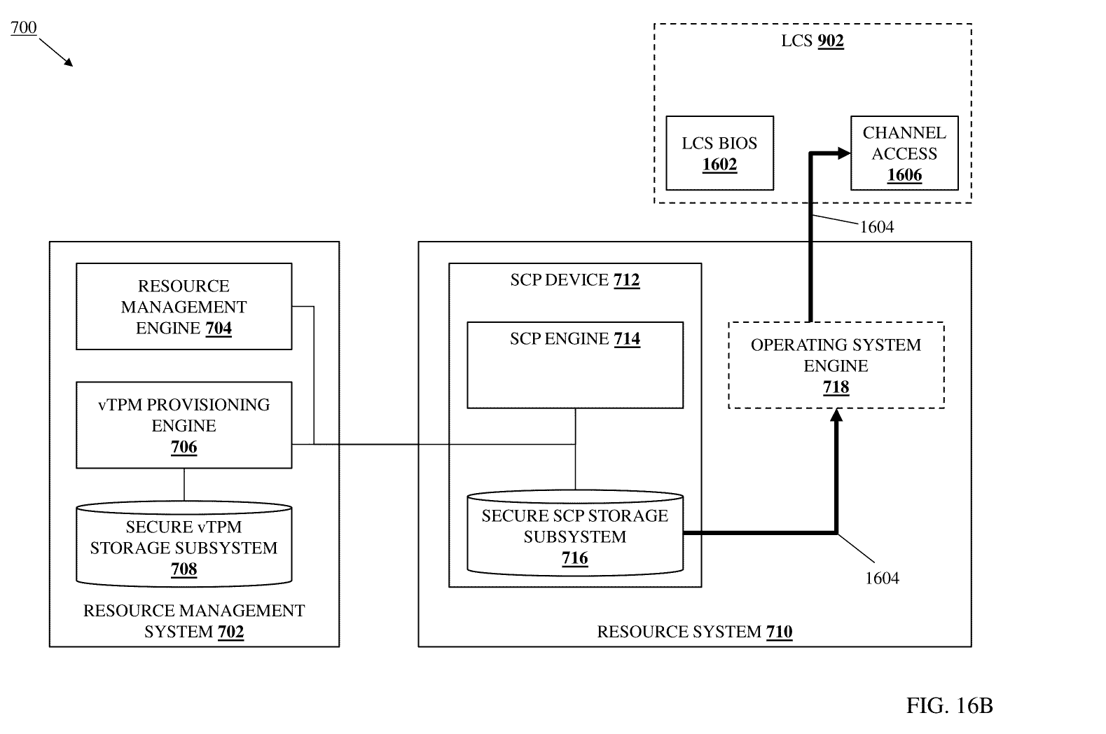

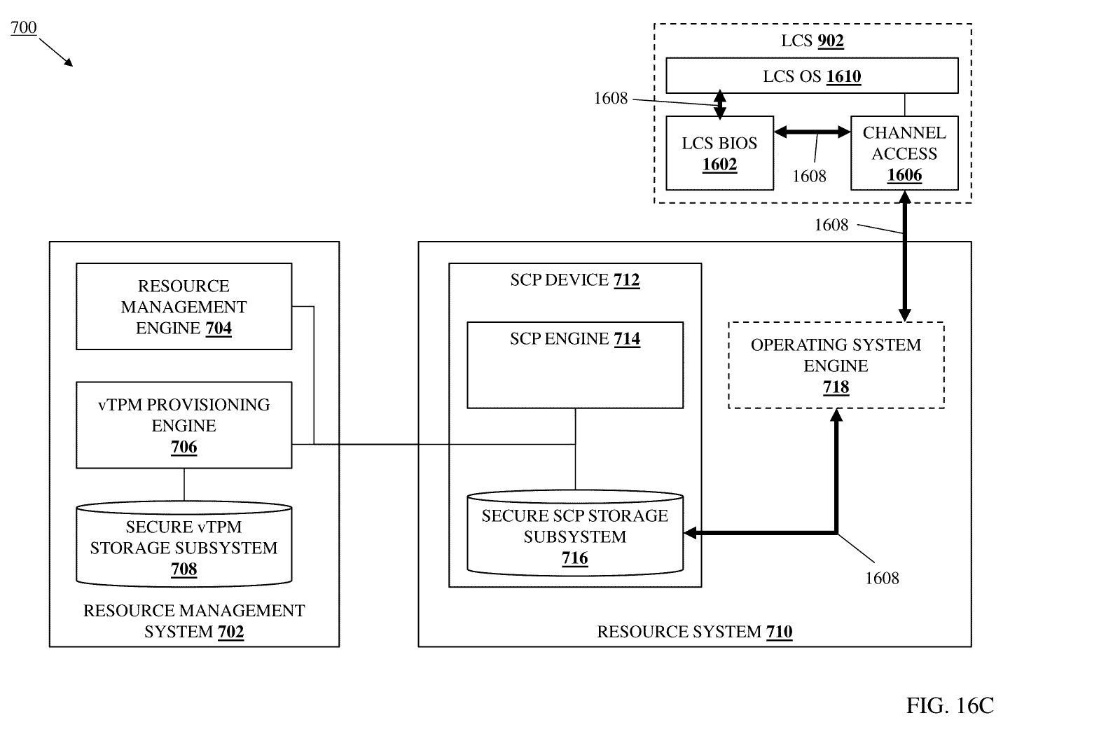

The method 800 then proceeds to block 812 where the resource system operating system uses the LCS initialization information and the LCS vTPM to provide the LCS. With reference to FIG. 16A, in an embodiment of block 812, the operating system engine 718 may perform LCS BIOS provisioning operations 1600 that include using the secure communications channel 1402 to the secure SCP storage subsystem 716 to access the LCS vTPM for the LCS 902, and using information included in that LCS vTPM with the LCS initialization information received at block 802 to provide an LCS BIOS 1602 (e.g., on hardware composed for the LCS 902 as described above). For example, at block 812, the operating system engine 718 may “stitch” the BIOS/UEFI block received at block 802 of the method 800 and information stored in the LCS vTPM for the LS 902 in order to provide the LCS BIOS 1602 (e.g., the microvisor that provides the operating system engine 718 may build a logical construct for the LCS 902 by assembling the virtual hardware (e.g., a virtual BIOS, a virtual TPM, a virtual bus, etc.) that appears as physical hardware to the LCS 902, as well as the initialization software used to initialize that LCS 902), although other techniques for providing the LCS BIOS 1602 will fall within the scope of the present disclosure as well.

With reference to FIG. 16B, in an embodiment of block 812, the operating system engine 718 may then perform secure channel access provisioning operations 1604 that include providing secure channel access 1606 in the LCS 902 to the secure communications channel 1402 it has with the secure SCP storage subsystem 716. For example, the provisioning of the secure channel access 1606 at block 812 may include creating an LCS vTPM access tunnel (i.e., including tunnel endpoints, the certificates they need to communicate, etc.) from the LCS 902 to the secure communication channel 1402 provided for the operating system engine 718, and/or using other secure channel access provisioning techniques that would be apparent to one of skill in the art in possession of the present disclosure. As will be appreciated by one of skill in the art in possession of the present disclosure, the secure channel access 1606 may be provided by an operating system service (e.g., a microvisor service) that presents the context space of the LCS vTPM for the LCS 902 in the secure SCP storage subsystem 716 to the LCS 902.

With reference to FIG. 16C, in an embodiment of block 812, the LCS BIOS 1602 may then perform LCS operating system provision operations 1608 that include utilizing the secure channel access 1606 to the secure communications channel 1402 between the operating system engine 718 and the secure SCP storage subsystem 716 to access the LCS vTPM for the LCS 902, and using information in the LCS vTPM for the LCS 902 to provide an LCS operating system 1610. As be seen FIG. 16C, the LCS operating system 1610 is provided by the LCS BIOS 1602 such that it is connected to the secure channel access 1606 and thus may use the secure communication channel 1402 between the operating system engine 718 and the secure SCP storage subsystem 716 to access the LCS vTPM for the LCS 902 as described below. As will be appreciated by one of skill in the art in possession of the present disclosure, following block 812, the LCS operating system 1610 may operate to provide the LCS 902 that operates to perform the workload defined by the workload intent received from the user as described above.

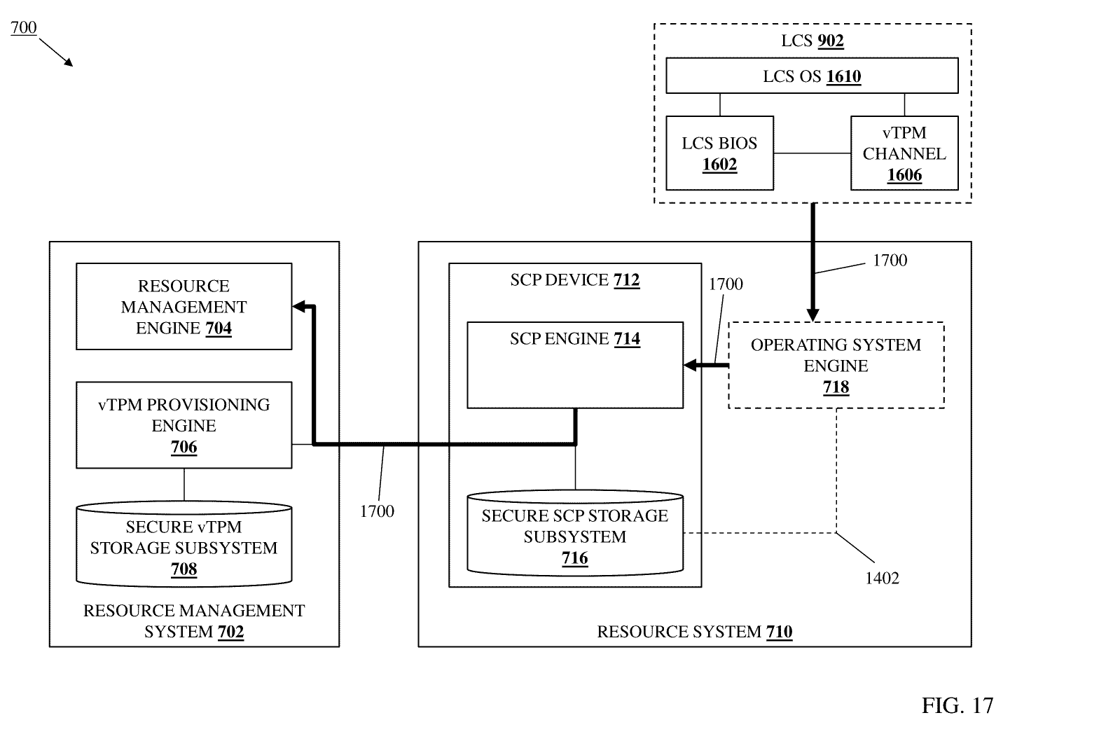

With reference to FIG. 17, subsequent to the method 800, the SCP engine 714 in the SCP device 712 of the resource system 710 may perform LCS state information synchronization operations 1700 that include retrieving LCS state information for the LCS 902 that identifies the current operating state of the LCS 902, and providing that LCS state information for the LCS 902 to the resource management engine 704 in the resource management system 702. As will be appreciated by one of skill in the art in possession of the present disclosure, the periodic synchronization of LCS state information for the LCS 902 with the resource management system 702 allows the LCS 902 to be quickly and easily migrated across different resource systems coupled to the resource management system 702.

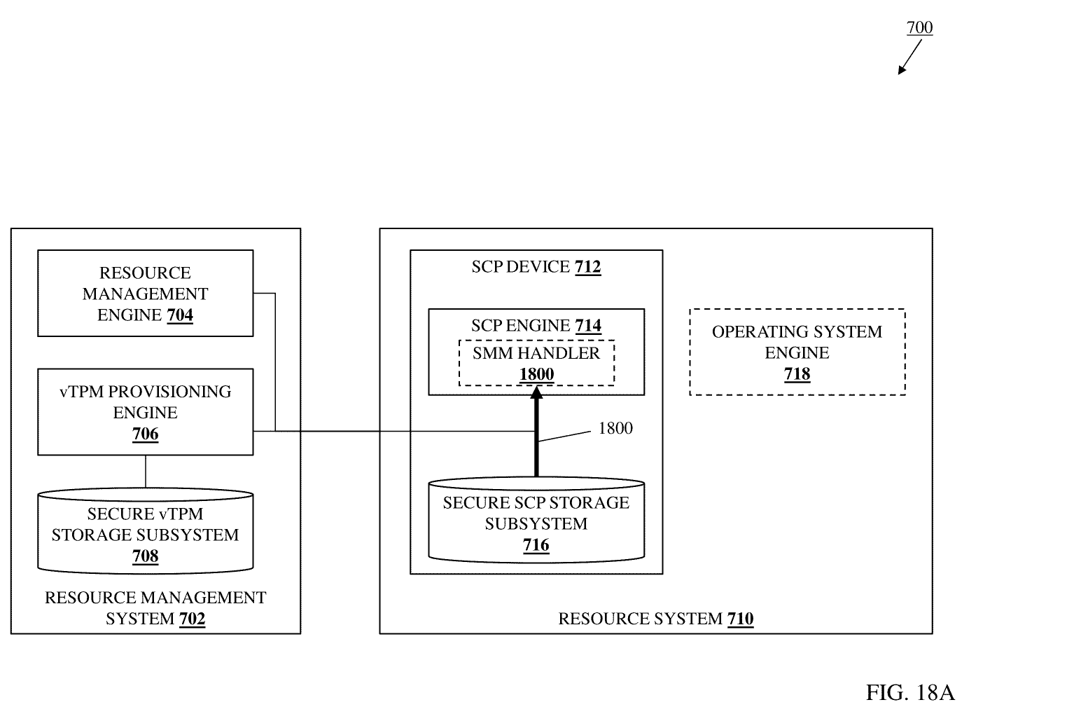

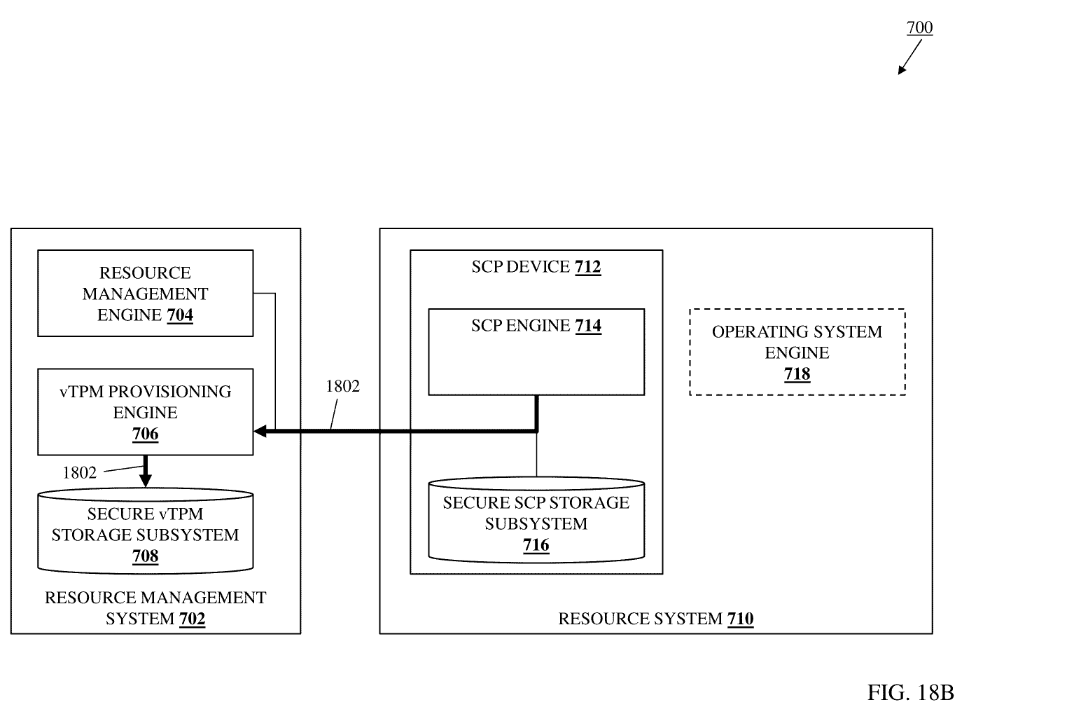

For example, with reference to FIG. 18A, the LCS 902 may be stopped (e.g., the operating system engine 718 may cease providing the LCS 902) following a most recent performance of the LCS state information synchronization operations 1700 discussed above. In response, the SCP engine 714 in the SCP device 712 of the resource system 710 may perform vTPM information retrieval operations 1800 that include entering an SMM in which an SMM handler 1800 is provided by the SCP engine 714 (e.g., similarly as the SMM handler 1302 discussed above), using the SMM handler 1800 to access the LCS vTPM for the LCS 902, generating vTPM information for the LCS 902 using the LCS vTPM for the LCS 902, and encrypting the vTPM information for the LCS 902 to provide encrypted vTPM information, after which the SCP engine 714 may exit the SMM.

With reference to FIG. 18B, the SCP engine 714 in the SCP device 712 of the resource system 704 may then perform vTPM information storage operations 1802 that include providing the encrypted vTPM information for the LCS 902 to the vTPM provisioning engine 706 in the resource management system 702, and the vTPM provisioning engine 706 storing the encrypted vTPM information for the LCS 902 in the secure vTPM storage subsystem 708. Following the storage of the encrypted vTPM information for the LCS 902 in the secure vTPM storage subsystem 708, one of skill in the art in possession of the present disclosure will appreciate how the method 800 may be repeated using any resource system that is accessible to the resource management engine 704 to migrate the LCS (previously LCS 902) to that resource system using its state information and vTPM information, with that LCS operating substantially as the LCS 902 did immediately prior to the stopping of the LCS 902. As such, the systems and methods of the present disclosure enhance the portability of LCSs in a secure manner via the ability to migrate the LCS vTPMs for those LCSs.

Furthermore, one of skill in the art in possession of the present disclosure will appreciate how a control plane provided by the resource management system 702 and the SCP device 712 may operate to manage read and write access to the contents of LCSs vTPMs stored in the secure SCP storage subsystem 716. For example, the SCP engine 714 may authenticate (e.g., based on one or more policies received from the resource management system 702) that any LCS is allowed to access its LCS vTPM in order to read data therefrom or write data thereto, and any changes to an LCS vTPM by its LCS (i.e., via the writing of data thereto as described above) may be encrypted by the SCP engine 714 (e.g., in the SMM similarly as described above) and provided to the vTPM provisioning engine 706 in the resource management system 702 for storage in the secure vTPM storage subsystem 708.

Thus, systems and methods have been described that use an SCP device to provide the LCS initialization information and vTPM needed by a resource system operating system to provide an LCS. For example, the secure LCS provisioning system of the present disclosure may include a resource system coupled to a resource management system and including a resource system operating system and an SCP device. The SCP device receives LCS initialization information for an LCS from the resource management system and provides it to the resource system operating system. The SCP device also receives vTPM information for the LCS from the resource management system and uses it to provide an LCS vTPM for the LCS in a secure SCP storage subsystem. The SCP device then provides a secure communication channel between the resource system operating system and the secure SCP storage subsystem, and identifies a location of the LCS vTPM in the secure SCP storage subsystem to the resource system operating system, allowing the resource system operating system to access the LCS vTPM and use it with the LCS initialization information to provide an LCS. As such, the provisioning of LCSs is secured by the SCP device and, as described above, the migration of such LCSs is simplified as well.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A secure Logically Composed System (LCS) provisioning system, comprising:
a resource management system; and
a resource system that is coupled to the resource management system and that includes:
a resource system operating system; and
an SCP device that is configured to:
receive, from the resource management system, Logically Composed System (LCS) initialization information for an LCS;
provide the LCS initialization information to the resource system operating system;
receive, from the resource management system, virtual Trusted Platform Module (vTPM) information for the LCS;
provide, using the vTPM information, an LCS vTPM for the LCS in a secure SCP storage subsystem;
provide a secure communication channel between the resource system operating system and the secure SCP storage subsystem; and
identify, to the resource system operating system, a location of the LCS vTPM in the secure SCP storage subsystem,
wherein the resource system operating system is configured to:
access the LCS vTPM at the location in the secure SCP storage subsystem via the secure communication channel and use the LCS vTPM with the LCS initialization information to provide an LCS.

2. The system of claim 1, wherein the vTPM information for the LCS that is received from the resource management system is encrypted vTPM information for the LCS, and wherein the SCP device is configured to:
store the encrypted vTPM information for the LCS in the secure SCP storage subsystem;
enter a System Management Mode (SMM);
decrypt, while in the SMM, the encrypted vTPM information for the LCS to provide the vTPM information for the LCS;
authenticate, while in the SMM, the vTPM information for the LCS; and
provide, while in the SMM and in response to the authentication of the vTPM information for the LCS, the LCS vTPM in the secure SCP storage subsystem.

3. The system of claim 1, wherein the SCP device is configured to:
map the LCS vTPM to the LCS in a per-LCS/vTPM map that is stored in the secure SCP storage subsystem.

4. The system of claim 1, wherein the using the LCS initialization information and the LCS vTPM to provide the LCS includes:
using the LCS initialization information to provide an LCS Basic Input/Output System (BIOS) for the LCS; and
providing the LCS BIOS access to the secure communication channel between the resource system operating system and the secure SCP storage subsystem, wherein the LCS BIOS is configured to access the LCS vTPM in the secure SCP storage subsystem via the secure communication channel and use the LCS vTPM to provide an LCS operating system for the LCS.

5. The system of claim 1, wherein the SCP device is configured to:
retrieve LCS state information for the LCS from the LCS during operation of the LCS; and
provide the LCS state information to the resource management system.

6. The system of claim 5, wherein the SCP device is configured to:
retrieve the LCS vTPM from the secure SCP storage subsystem; and
provide the LCS vTPM to the resource management system.

7. The system of claim 1, wherein the resource management system is configured to:
migrate the LCS using the LCS state information and the LCS vTPM.

8. An Information Handling System (IHS), comprising:
a resource system processing system;
a resource system memory system that is coupled to the resource system processing system and that includes instructions that, when executed by the resource system processing system, cause the resource system processing system to provide a resource system operating system engine;
a System Control Processor (SCP) processing system; and
an SCP memory system that is coupled to the SCP processing system and that includes instructions that, when executed by the SCP processing system, cause the SCP processing system to provide an SCP engine that is configured to:
receive, from a resource management system, Logically Composed System (LCS) initialization information for an LCS;
provide the LCS initialization information to the resource system operating system engine;
receive, from the resource management system, virtual Trusted Platform Module (vTPM) information for the LCS;
provide, using the vTPM information, an LCS vTPM for the LCS in a secure SCP storage subsystem;
provide a secure communication channel between the resource system processing system and the secure SCP storage subsystem; and
identify, to the resource system operating system engine, a location of the LCS vTPM in the secure SCP storage subsystem,
wherein the resource system operating system engine is configured to:
access the LCS vTPM at the location in the secure SCP storage subsystem via the secure communication channel and use the LCS vTPM with the LCS initialization information to provide an LCS.

9. The IHS of claim 8, wherein the vTPM information for the LCS that is received from the resource management system is encrypted vTPM information for the LCS, and wherein the SCP engine is configured to:
store the encrypted vTPM information for the LCS in the secure SCP storage subsystem;
enter a System Management Mode (SMM);
decrypt, while in the SMM, the encrypted vTPM information for the LCS to provide the vTPM information for the LCS;
authenticate, while in the SMM, the vTPM information for the LCS; and
provide, while in the SMM and in response to the authentication of the vTPM information for the LCS, the LCS vTPM in the secure SCP storage subsystem.

10. The IHS of claim 8, wherein the SCP engine is configured to:
map the LCS vTPM to the LCS in a per-LCS/vTPM map that is stored in the secure SCP storage subsystem.

11. The IHS of claim 8, wherein the using the LCS initialization information and the LCS vTPM to provide the LCS includes:
using the LCS initialization information to provide an LCS Basic Input/Output System (BIOS) for the LCS; and
providing the LCS BIOS access to the secure communication channel between the resource system operating system and the secure SCP storage subsystem, wherein the LCS BIOS is configured to access the LCS vTPM in the secure SCP storage subsystem via the secure communication channel and use the LCS vTPM to provide an LCS operating system for the LCS.

12. The IHS of claim 8, wherein the SCP engine is configured to:
retrieve LCS state information for the LCS from the LCS during operation of the LCS; and
provide the LCS state information to the resource management system.

13. The IHS of claim 8, wherein the SCP engine is configured to:
retrieve the LCS vTPM from the secure SCP storage subsystem; and
provide the LCS vTPM to the resource management system.

14. A method for securely providing a Logically Composed System (LCS), comprising:
receiving, by a System Control Processor (SCP) device from a resource management system, Logically Composed System (LCS) initialization information for an LCS;
providing, by the SCP device, the LCS initialization information to a resource system operating system;
receiving, by the SCP device from the resource management system, virtual Trusted Platform Module (vTPM) information for the LCS;
providing, by the SCP device using the vTPM information, an LCS vTPM for the LCS in a secure SCP storage subsystem;
providing, by the SCP device, a secure communication channel between the resource system operating system and the secure SCP storage subsystem;
identifying, by the SCP device to the resource system operating system, a location of the LCS vTPM in the secure SCP storage subsystem; and
accessing, by the resource system operating system, the LCS vTPM at the location in the secure SCP storage subsystem via the secure communication channel and use the LCS vTPM with the LCS initialization information to provide an LCS.

15. The method of claim 14, wherein the vTPM information for the LCS that is received from the resource management system is encrypted vTPM information for the LCS, and wherein the method further comprises:
storing, by the SCP device, the encrypted vTPM information for the LCS in the secure SCP storage subsystem;
entering, by the SCP device, a System Management Mode (SMM);
decrypting, by the SCP device while in the SMM, the encrypted vTPM information for the LCS to provide the vTPM information for the LCS;
authenticating, by the SCP device while in the SMM, the vTPM information for the LCS; and
providing, by the SCP device while in the SMM and in response to the authentication of the vTPM information for the LCS, the LCS vTPM in the secure SCP storage subsystem.

16. The method of claim 14, further comprising:
mapping, by the SCP device, the LCS vTPM to the LCS in a per-LCS/vTPM map that is stored in the secure SCP storage subsystem.

17. The method of claim 14, wherein the using the LCS initialization information and the LCS vTPM to provide the LCS includes:
using the LCS initialization information to provide an LCS Basic Input/Output System (BIOS) for the LCS; and
providing the LCS BIOS access to the secure communication channel between the resource system operating system and the secure SCP storage subsystem, wherein the LCS BIOS is configured to access the LCS vTPM in the secure SCP storage subsystem via the secure communication channel and use the LCS vTPM to provide an LCS operating system for the LCS.

18. The method of claim 14, further comprising:
retrieving, by the SCP device, LCS state information for the LCS from the LCS during operation of the LCS; and
providing, by the SCP device, the LCS state information to the resource management system.

19. The method of claim 18, further comprising:
retrieving, by the SCP device, the LCS vTPM from the secure SCP storage subsystem; and
providing, by the SCP device, the LCS vTPM to the resource management system.

20. The method of claim 19, further comprising:
migrating, by the resource management system, the LCS using the LCS state information and the LCS vTPM.
